(19) United States
(12) Patent Application Publication
(10) Pub. No.: US 2011/0115703 A1
(43) Pub. Date: May 19, 2011

(54) INFORMATION DISPLAY SYSTEM

(75) Inventors: Yoichi IBA, Tokyo (JP); Ryohei Sugihara, Tokyo (JP); Seiji Tatsuta, Tokyo (JP)

(73) Assignee: OLYMPUS CORPORATION, Tokyo (JP)

(21) Appl. No.: 13/004,576

(22) Filed: Jan. 11, 2011

Related U.S. Application Data
(62) Division of application No. 11/636,752, filed on Dec. 11, 2006, now abandoned.

(30) Foreign Application Priority Data
Dec. 12, 2005 (JP) JP 2005-357345

(51) Int. Cl. G06F 3/01; G09G 5/00

(52) U.S. Cl. 345/156; 345/8

(57) ABSTRACT

A head-worn information display system which includes a display panel. A display mode of information displayed on the display panel is switched automatically according to an active state of a user using the information display system, so as to display information appropriate for the active state of the user.

### CROSS-REFERENCE TO RELATED APPLICATION

The present application is a Divisional Application of U.S. application Ser. No. 11/636,752 filed on Dec. 11, 2006, which is based upon and claims the benefit of priority from the prior Japanese Patent Application No. 2005-357345 filed on Dec. 12, 2005, the entire contents of each of which are incorporated herein by reference.

### BACKGROUND OF THE INVENTION

1. Field of the Invention

The present invention relates to an information display system, and particularly to a head-mount information display system.

2. Description of the Related Art

Various information display systems for observing image information displayed on a display section by wearing on a head of a user have been hitherto proposed (refer to Japanese Patent Application Laid-open Publication No. Hei 7-261112, Japanese Patent Application Laid-open Publication No. Hei 7-294844, and Japanese Patent Application Laid-open Publication No. 2004-236242, for example). Structures such as a spectacle type, a goggle type, and a helmet type of a head-mount information display system, which is a so called head-mount display, have been hitherto known.

With an advancement of a reduction in size of the head-mount information display system, a scope of use is becoming wide. For example, a case of the user wearing a small size information display system all the time can also be considered. In the information display system worn all the time, the user can observe all the time, visual information of an outside field. Moreover, an electronic image is superimposed on a view of the outside field by the information display apparatus

An “always wearable information display system” means an information display system which is structured to be able to wear even when the user has no intention of using the information display system, in addition to an information display system which is used intentionally by the user. Therefore, the “always wearable information display system” is a lightweight and small size system structured to ensure a field of view of outside.

An active state of the user keeps on changing in day to day life indoors, outdoors, during walking, and during uttering. Here, even in a case of the same information content, it is desirable to change a mode of information to be displayed according to the active state, when deemed appropriate. For example, when an example is taken of a case of displaying a timetable of a train by superimposing on a field of view of a naked eye by the information display system, a large icon display is preferable when the user is walking, and a display of detailed character information is preferable when the user is not walking (when the user is at halt) as the user can concentrate on perceiving the displayed information.

### SUMMARY OF THE INVENTION

According to the present invention, there can be provided a head-mount information display system including at least a display device, in which a display of information displayed on the display device is switched automatically according to an active state of a user who is using the information display system.

### BRIEF DESCRIPTION OF THE DRAWINGS

FIG. 1 is a diagram showing a front view of a structure of an information display system according to a first embodiment of the present invention;

FIG. 2 is a diagram showing a side view of the structure of the information display system according to the first embodiment;

FIG. 3 is a diagram showing a plan view of the structure of the information display system of the first embodiment;

FIG. 4 is a diagram showing a display optical system in the first embodiment;

FIG. 5 is another diagram showing the display optical system in the first embodiment;

FIG. 6 is a diagram showing an imaging relation of the display optical system in the first embodiment;

FIG. 7A and FIG. 7B are enlarged views of an area near an eyeball of the information display system of the first embodiment;

FIG. 8 is a diagram showing an optical path of the display optical system in the first embodiment;

FIG. 9A and FIG. 9B are diagrams showing a see-through image in the first embodiment;

FIG. 10 is functional block diagram of the information display system according to the first embodiment;

FIG. 11 is diagram showing a user U wearing the information display system according to the first embodiment;

FIG. 12 is a diagram showing an optical path for detecting a gazing in the first embodiment;

FIG. 13 is a diagram showing another structure for detecting the gazing in the first embodiment;

FIG. 14A and FIG. 14B are diagrams showing an example of an electronic image in the first embodiment;

FIG. 15A and FIG. 15B are diagrams showing other examples of the electronic image in the first embodiment;

FIG. 16A and FIG. 16B are diagrams showing still other examples of the electronic image in the first embodiment;

FIG. 17 is a diagram showing an example of selection of the electronic image in the first embodiment;

FIG. 18A is a diagram showing fields, metadata, and items;

FIG. 18B is a diagram showing a switching of a display mode in the first embodiment;

FIG. 18C is a diagram showing as to which field having which metadata is to be displayed with respect to the active state in the first embodiment;

FIG. 19 is a functional block diagram of an information display system of modified embodiment of the first embodiment;

FIG. 20 is a flowchart showing a procedure of an information display of the first embodiment;

FIG. 21 is a flowchart showing another procedure of the information display of the first embodiment;

FIG. 22 is a flowchart showing a procedure of an information display of a second embodiment;

FIG. 23 is a timing chart showing a communication timing of the second embodiment;

FIG. 24 is another timing chart showing the communication timing of the second embodiment;

FIG. 25 is a still another timing chart showing the communication timing of the second embodiment;

FIG. 26 is a still another timing chart showing the communication timing of the second embodiment;

FIG. 27 is a still another timing chart showing the communication timing of the second embodiment;

FIG. 28 is a flowchart showing a procedure of an information display of a third embodiment;

FIG. 29 is another flowchart showing a procedure of the information display of the third embodiment;

FIG. 30 is a still another flowchart showing a procedure of the information display of the third embodiment;

FIG. 31 is a still another flowchart showing a procedure of the information display of the third embodiment;

FIG. 32 is a diagram showing a structure as seen from a side view of an information display system according to a fourth embodiment;

FIG. 33 is a diagram showing a perspective structure of the information display system according to the fourth embodiment;

FIG. 34 is a flowchart showing a procedure of an information display in the fourth embodiment;

FIG. 35 is a diagram showing a turning of an eyepiece window in the fourth embodiment;

FIG. 36 is a diagram showing a numerical example of a structure of the eyepiece window near an eyeball in the fourth embodiment;

FIG. 37 is a diagram showing another numerical example of the structure of the eyepiece window near the eyeball in the fourth embodiment; and

FIG. 38 is a diagram showing a still another numerical example of the structure of the eyepiece window near the eyeball in the fourth embodiment;

### DETAILED DESCRIPTION OF THE PREFERRED EMBODIMENTS

Embodiments of an information display system of the present invention will be described below in detail with reference to the accompanying diagrams. However, the present invention is not restricted to the embodiments described below.

### First Embodiment

### Structure of Information Display System

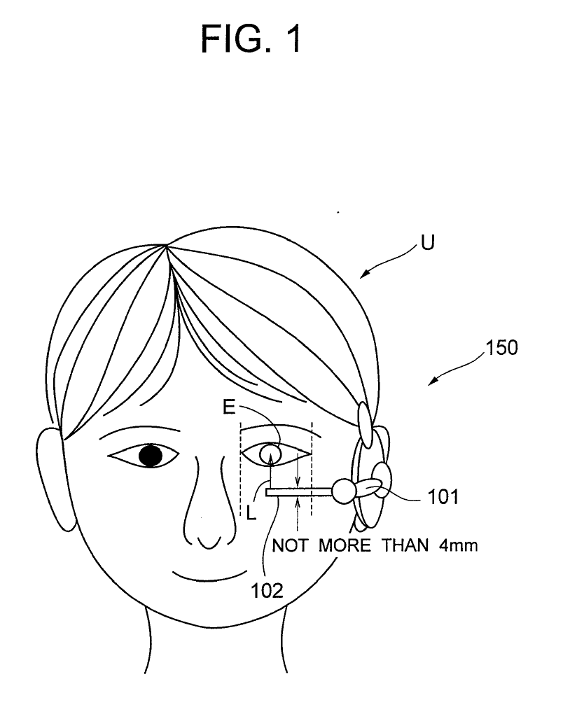

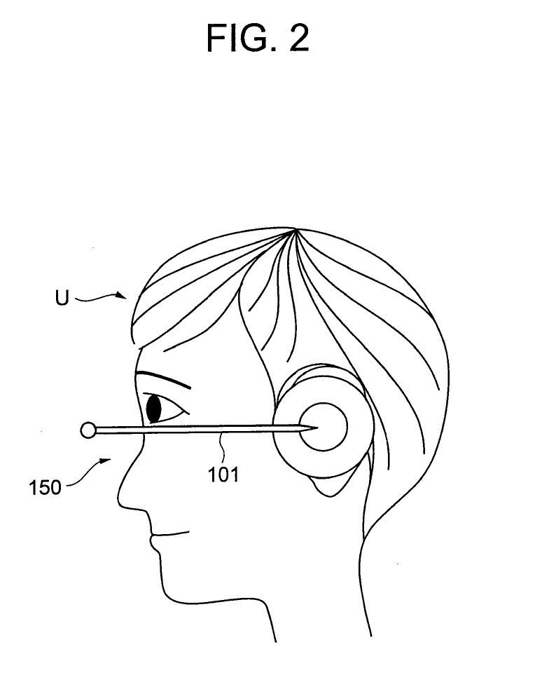

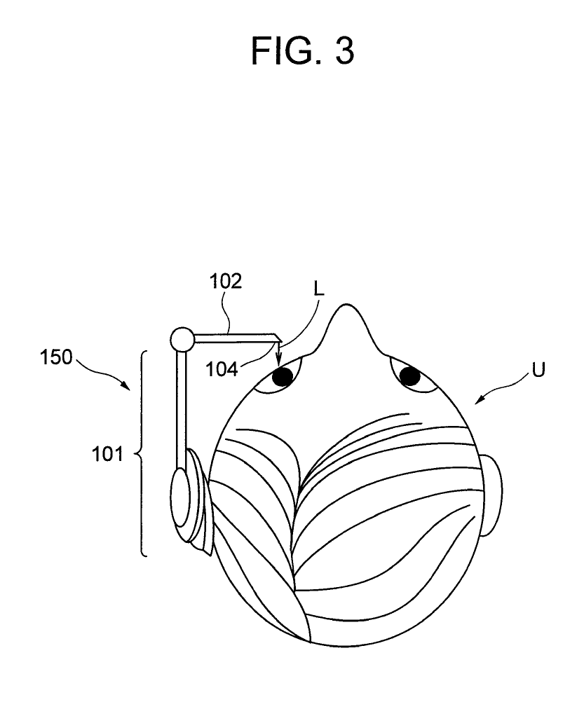

FIG. 1, FIG. 2, and FIG. 3 show a schematic structure of an MEG 150 which is one of information display systems 100 according to a first embodiment of the present invention. The MEG is an abbreviation of “Mobiler Eye Glass”. FIG. 1 shows a structure in which a user U using the MEG 150 is viewed from a front. FIG. 2 shows a structure in which the user U using the MEG 150 is viewed from a side. Moreover, FIG. 3 shows a structure in which the user U using the MEG 150 is viewed from a top.

The MEG 150 is structured such that one end of a head supporting section 101 of the MEG 150 is held by a head of the user U. Moreover, an eyepiece window holding section 102 in the form of a rod is formed on the other end of the head supporting section 101. An eyepiece window (exit window) 104 is provided at a front end portion of the eyepiece window holding section 102.

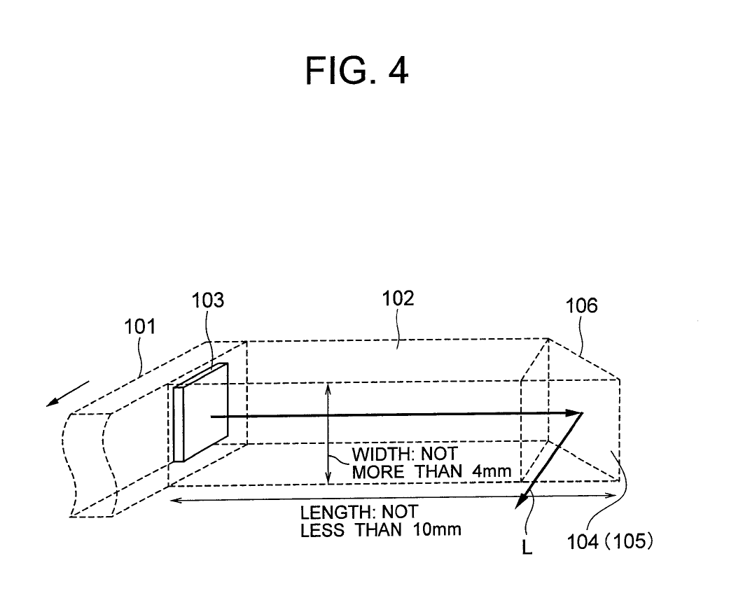

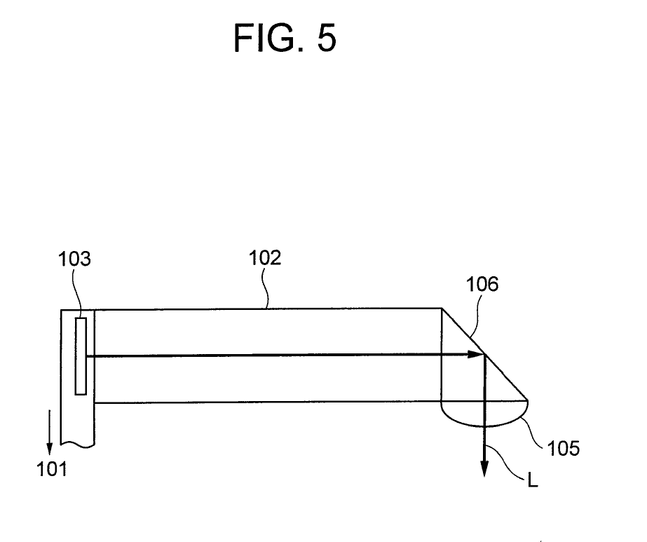

The eyepiece window holding section 102 holds the eyepiece window 104 in a field of view of a naked eye of the user U. An eyepiece window 104 is a window for irradiating towards the naked eye of the user U a light beam L which forms a virtual image of an electronic image displayed on a display panel 103 (refer to FIG. 4 and FIG. 5). Moreover, a member in the form of a rod forming the eyepiece window holding section 102 is extended in a range of not less than 10 mm from the eyepiece window 104 to a bottom, and a width of a projected cross section in a direction of a visual axis of the user is not more than 4 mm except for a partial protrusion.

The MEG 150 is an example in which a small size headphone type head supporting section 101 is used. The eyepiece window holding section 102 includes a light guiding path integrated therein for enabling to observe the display panel 103 (refer to FIG. 4 and FIG. 5) positioned at an end portion of a face of the user. The eyepiece window holding section 102 is extended from the head supporting section 101 up to an area near a front surface of the eyeball E. The user U can perceive an image displayed by looking into the eyepiece window 104 at the front end portion of the eyepiece window holding section 102. At this time, all parts positioned in a range of a front view of the eyeball (refer to FIG. 1) are set to have a width not more than 4 mm in order to avoid obstructing observation of external view.

Next, a reason for setting all the parts positioned in the range of the front view of the eyeball to have the width not more than 4 mm will be described below. A diameter of a human pupil changes in a range of 2 mm to 8 mm according to a brightness. When a shielding member disposed in front of the eyeball is smaller than the diameter of the pupil, a view of a distant object is not blocked by the shielding member and the distant object can be observed. Here, a member which forms the eyepiece window holding section 102 which is a casing part positioned in the range of the front view of the eyeball is set to a size not more than 4 mm with the average size of the diameter of pupil as a base. Accordingly, in a normal environment of use of the user U, it is possible to observe the outside field without being shielded.

Moreover, the headphone type head supporting section 101 includes a display panel driving circuit, a received data processing circuit, and a wireless receiving means integrated therein, which will be described later.

FIG. 4 shows a structure of a portion of a display optical system in the structure in FIG. 1, as viewed in a perspective view. Moreover, FIG. 5 shows a structure of the portion of the display optical system as viewed from a top. Image light irradiated from the display panel 103 which is integrated in an area near and edge of incidence of the eyepiece window holding section 102 is advanced through the eyepiece window holding section 102. Further, an optical path of the image light is folded through 90° by a reflecting member 106. The image light with the optical path bent thereof is irradiated from the eyepiece window 104 in a direction of the pupil E. The user U can observe the electronic image displayed on the display panel 103 by looking into the eyepiece window 104.

Thus, display optical system includes the eyepiece window holding section 102, the reflecting member 106, and an eyepiece lens 105. The display optical system is an optical system for an enlarged projection in air of an electronic image on the display panel 103. The display optical system can have various structures such as a structure with one lens, a structure with a combination of a prism and a lens, and a structure having a plurality of mirrors and lenses. Further, the eyepiece window 104 corresponds to an optical aperture section nearest to the eyeball E of the display optical system.

As viewed from a direction of the user U, a left end of the eyepiece window holding section 102 is joined to the head supporting section 101. In this case, a width of the eyepiece window holding section 102 as viewed from the direction of the user U is not more than 4 mm, and a length of the eyepiece window holding section 102 is not less than 10 mm.

Moreover, as the reflecting member 106, any member which reflects light rays, and a prism or a mirror etc. can be used. Furthermore, as the display panel 103, be any small display panel, and a transparent or a reflecting liquid crystal display device, a light emitting organic EL device and an inorganic EL device can be used.

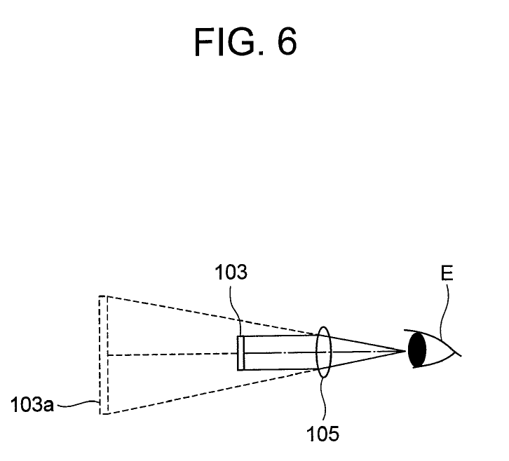

FIG. 6 shows a basic structure of an optical system of the information display system 100. The display panel 103 is disposed at a position nearer than a critical near point of accommodation of the eyeball E. The eyepiece lens 105 projects image light from the display panel 103 on the eyeball E. The user U can observe upon enlarging an aerial image 103a which is a virtual image of the display panel 103. By such structure, even by using the small display panel 103, the electronic image can be observed by a wide angle of field of observation.

The eyepiece lens 105 may be any optical system having a positive refractive power. For example, a convex lens, a concave mirror, and a lens having heterogeneous refractive index can be used as the eyepiece lens 105. Moreover, a group of lenses having a positive refractive power formed by a combination of a plurality of optical elements having a plus refractive power or a minus refractive power may be used as the eyepiece lens 105.

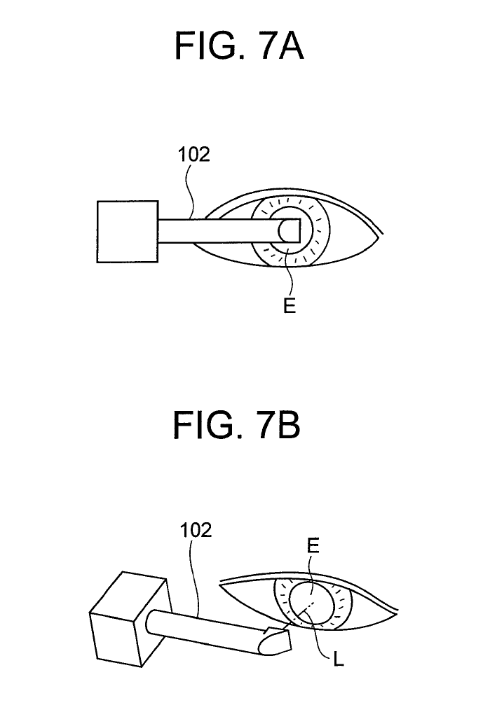

Thus, as shown in FIGS. 7A and 7B, the length of the eyepiece window holding section 102 which is a shielding member positioned in front of the eyeball E is let to be not less than 10 mm, and is let to be thinner than 4 mm which is an average diameter of the human pupil. Accordingly, light beam from the outside field is not shielded completely, and an outside field image on a side of the eyepiece window holding section 102 opposite to the eyeball E is seen through the eyepiece window 104 as if the eyepiece window 104 is transparent, and can be checked visually. The light beam L of the electronic image is emerged from the eyepiece window 104. Therefore, the electronic image and the image of the outside field (actual field of view) can be seen as superimposed (overlapped) images. Accordingly, a see-through effect can be achieved.

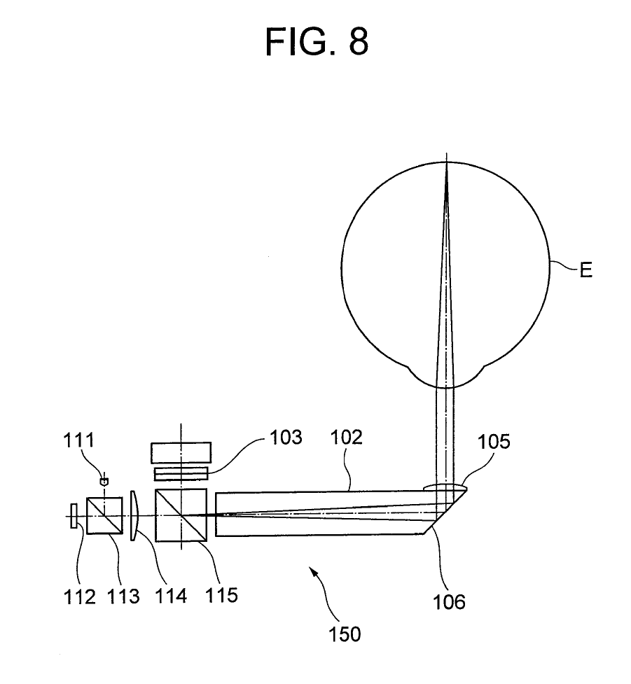

FIG. 8 shows an optical path from the MEG 150 up to the eyeball E. Further, FIG. 8 shows an optical system provided with a structure for detecting a gazing of the electronic image by the user U. The structure for detecting the gazing of the electronic image will be described later. An optical path of a light beam from the display panel 103 is bent through 90° at a prism 115, and the light beam advances through the eyepiece window holding section 102. The light beam upon passing through the reflecting member 106 and the eyepiece lens 105 forms an electronic image on a retina of the eyeball E.

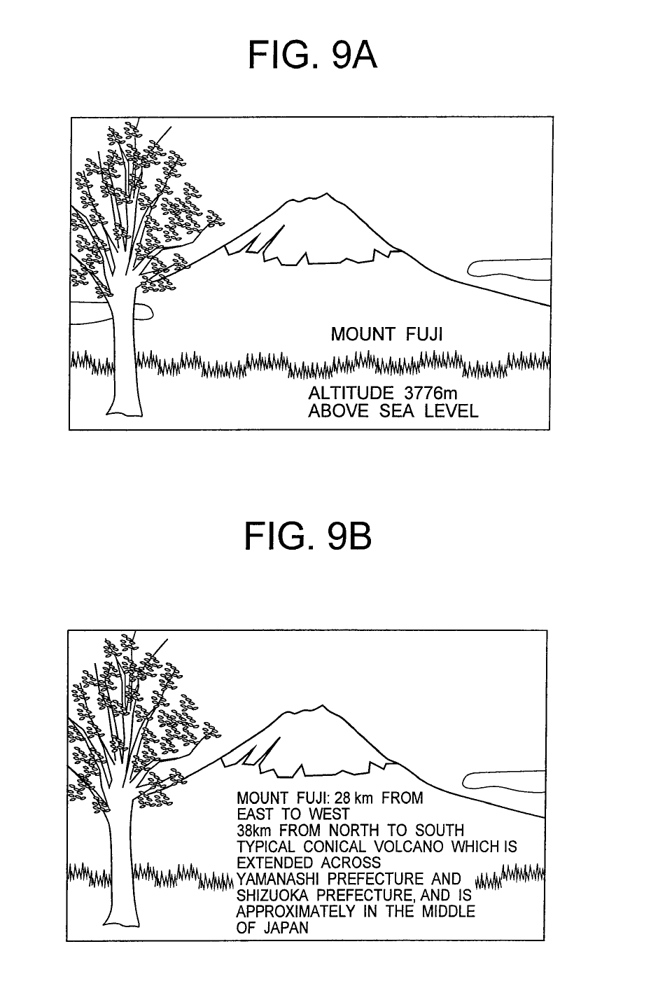

FIG. 9A and FIG. 9B show an example of the electronic image by the display panel 103 on which the superimposed images are displayed, and a field of view of outside seen by the user U. The user U is observing Mount. Fuji by using the MEG 150. In FIG. 9A, character information “Mount Fuji”, “altitude 3776 m above sea level” is displayed in a field of view of the electronic image superimposed on Mount Fuji in the field of view of outside. Moreover, in FIG. 9B, character information in further details about Mount Fuji is displayed. Thus, by using the MEG 150, the user U can see electronic information by the display panel 103 overlapping with Mount Fuji in the field of view of outside. In other words, the user U can use the MEG 150 as a so-called see-through viewer.

### (Information Display System)

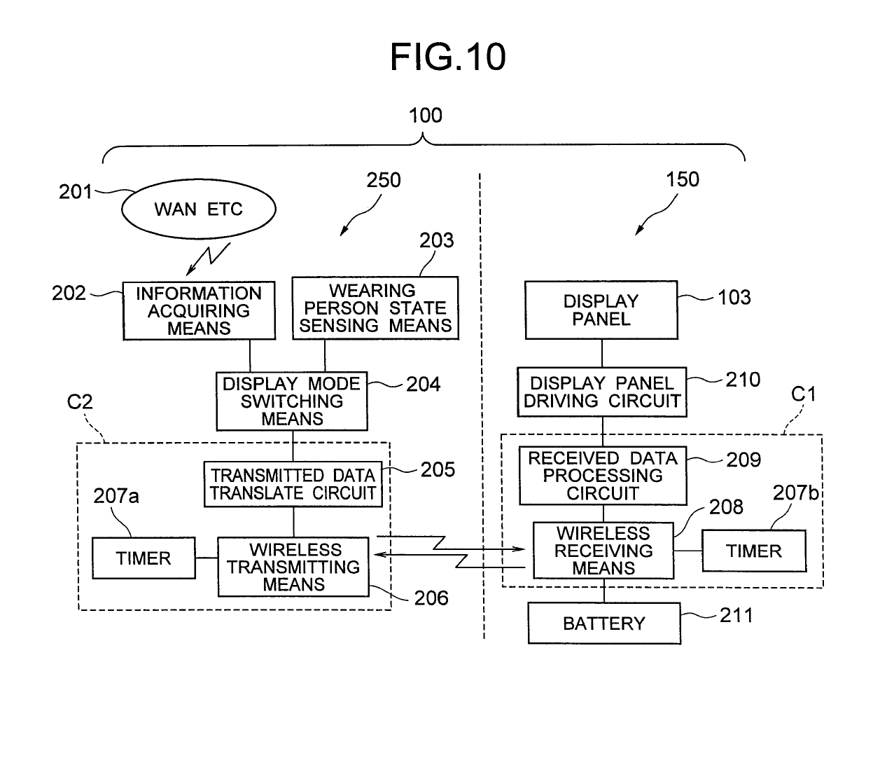

Next, the information display system 100 which includes the MEG 150 will be described. FIG. 10 is a block diagram showing a structure of the information display system 100.

The information display system 100 includes the MEG 150 and a portable unit 250. The portable unit 250 includes an information acquiring means 202, a wearing-person state sensing means 203, a display mode switching means 204, a transmission data translating circuit 205, a wireless transmitting means 206, and a timer 207a.

The information acquiring means 202 acquires information from other computer and database via a WAN (Wide Area Network) 201. Moreover, the wearing-person state sensing means 203 is a sensor for sensing an active state of the user U. These sensors will be described later.

The display mode switching means 204 switches a display mode of information displayed on the display panel 103 according to an active state of the user U. The transmission data translating circuit 205 translates information provided which is output by the display mode switching means 204 such as a markup language like HTML (Hyper Text Markup Language) which can describe a size and position of characters, to American Standard Code for Information Exchange (ASCII), and transmits to the wireless transmitting means 206. Moreover, the timer 207a is synchronized with a timer 207b integrated in the MEG 150 according a procedure which will be described later.

The MEG 150 includes the display panel 103 described above, a display panel driving circuit 210, a received data processing circuit 209, a wireless receiving means 208, and the timer 207b. The wireless transmitting means 206 and the wireless receiving means 208 include a Bluetooth chip for example, which is a transmitting section or a receiving section of the Bluetooth.

The wireless receiving means 208 transmits data received to the received data processing means 209. The received data processing means 209 converts the received data to an image signal which can be processed by the display panel driving circuit 210. The display panel driving circuit 210 drives the display panel 103. Further, the user U can see the electronic image on the display panel 103 via the MEG 150.

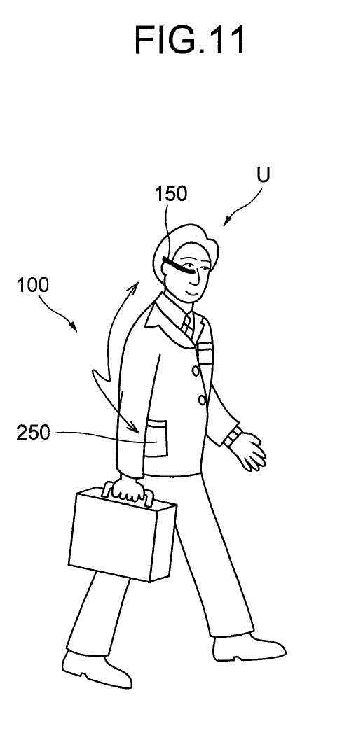

FIG. 11 shows a walking state of the user U wearing the information display system 100. The user U has worn the MEG 150 on the head. Moreover, the user U is carrying the portable unit 250 in a jacket. Further, the user U wears the MEG 150 all the time. In other words, the user U doesn't wear the MEG 150 only when intending to use the MEG 150, but uses the MEG 150 even when not intending to use the MEG 150. Thus, as it is described above, even when the user U is wearing the MEG 15C), the observation of the field of view of outside is not obstructed. Furthermore, the MEG 150 is structured to be a small sized and light weighted. Therefore, the user U can perform actions without being conscious of wearing the MEG 150 even when the MEG 150 is worn on the head.

### (Description of Active State)

Next, display examples of the electronic information by the MEG 150 will be described. The MEG 150 is structured such that a display mode of information displayed on the display panel 103 is switched automatically according to the active state of the user U. The active state of the user U means a state such as whether the user is walking or not. As to whether or not the user U is walking is detected by at least any one of an acceleration sensor, an inclination sensor, an angular velocity sensor, a vibration sensor, a heart-beat sensor, and a GPS.

The acceleration sensor detects acceleration of walking of the user U. The inclination sensor detects an inclination of a part of a body of the user U. When the user U walks, an inclination of the parts of the body such as an arm and a leg, changes regularly. For example, a wrist-watch type inclination sensor detects an inclination of a wrist. Moreover, by, providing the inclination sensor in a sole, an inclination of a plantar can be detected. The angular velocity sensor can detect an angular velocity of a part of the body due to walking of the user U. The vibration sensor detects vibrations caused due to walking of the walker U. The heart-beat sensor detects a pulse rate of the walker U. The GPS can detect the whereabouts and the direction of the user U. Moreover, instead of the GPS, position information service of a portable telephone can be used.

Other examples of the active state of the user U include a state in which the user U is gazing and not gazing at the electronic image of the display panel 103. As to whether or not the user U is gazing at the electronic image can be detected by a combination of an infrared ray irradiating means and an infrared ray sensor.

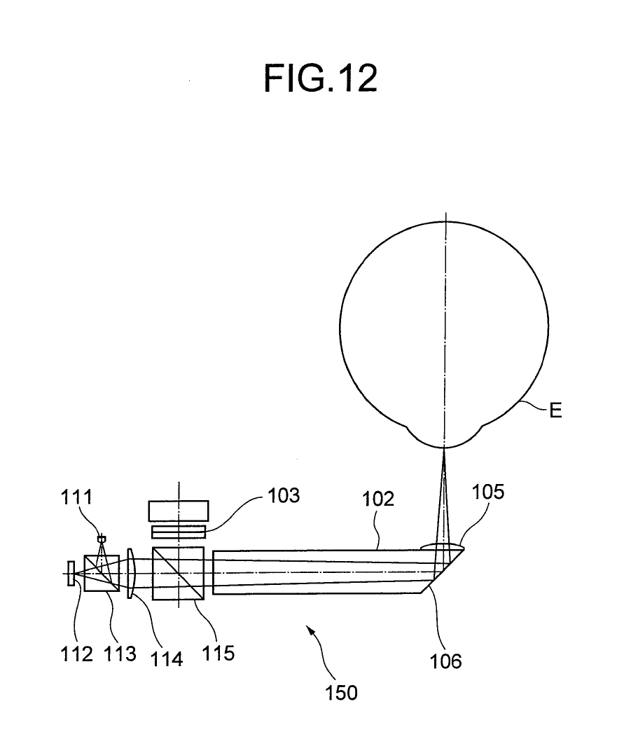

FIG. 12 shows a schematic structure of the MEG 150 which includes an optical system for detecting whether or not the user U is gazing. The infrared ray irradiating means, such as an infrared LED 111 irradiates infrared rays. An optical path of the infrared rays from the infrared LED 111 is bent through 90° at a prism 113. Further, the infrared rays are projected on a corneal surface of the eyeball E via a lens 114, the prism 115, the eyepiece window holding section 102, the reflecting member 106, and the eyepiece lens 105. When the eyeball E is turned to the eyepiece lens 105, in other words to the eyepiece window section, an optical axis of the eyepiece lens 105 and the corneal surface of the eyeball E are orthogonal. Therefore, the infrared rays projected from the eyepiece lens 105 are reflected at the corneal surface of the eyeball E following the similar optical path as when projected, and pass through the prism 113. The infrared rays passed through the prism 113 are incident on an infrared ray sensor 112. However, when the eyeball E is not turned to the eyepiece lens 105, the optical axis of the eyepiece lens 105 and the corneal surface of the eyeball E are not orthogonal, and the infrared rays reflected at the corneal surface of the eyeball E do not follow the same path as when projected. Therefore, intensity of the infrared rays incident on the infrared ray sensor 112 is weakened, or the infrared rays cannot reach the infrared ray sensor 112. Therefore, by detecting the intensity of the infrared rays reflected from the eyeball E, it is possible to detect whether or not the user U is gazing at the electronic image on the display panel 103.

Moreover, as to whether or not the user is gazing the electronic image can also be detected by a myoelectric potential sensor. As the myoelectric potential sensor, an EOG (electro-oculogram) method can be used. The EOG method is a method of detecting a change in an electric potential due to a movement of an eyeball by using a positive resting potential existing on a side of the cornea and a negative resting potential existing on a side of the retina.

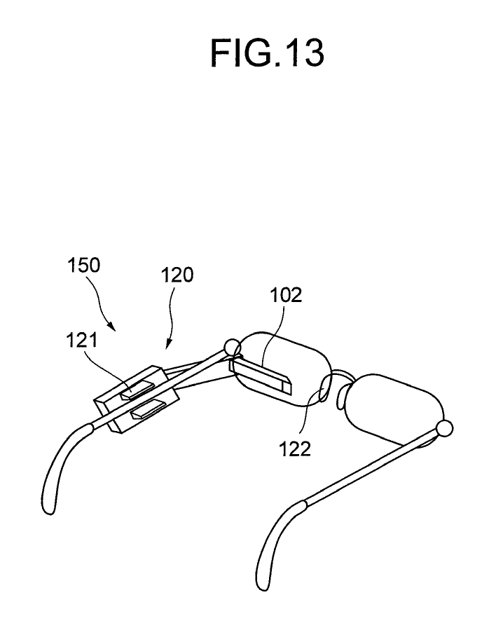

FIG. 13 shows a perspective view of the MEG 150 which includes a myoelectric potential sensor 120. The myoelectric potential sensor 120 has two myoelectric potential sensor electrodes 121 and 122. The myoelectric potential sensor electrodes 121 and 122 detect an electric potential caused due to a movement of the eyeball E. The detected electric potential is compared with an electric potential stored in advance in a memory which is measured by myoelectric potential sensor when the electronic image is gazed. Upon comparing the detected electric potential, when the detected electric potential is substantially equal to the memorized electric potential, the electronic image is judged to have been gazed, and when the detected electric potential is not substantially equal to the memorized electric potential, the electronic image is judged not to have been gazed. By such EOG method, it is possible to detect as to whether or not the eyeball E has gazed the electronic image.

A still another example of the active state of the user U is a state of whether or not the user U is uttering. The uttering state of the user U can be detected by a microphone worn by the user U which picks up efficiently sounds in the body.

When the user U utters, voice is propagated from a mouth to an outside of the body, but a part of the voice is propagated to an inside of the body. It is possible to detect the voice of the user U by the microphone which picks up efficiently the sound in the body due to the uttering of the user U. On the other hand, an outside sound is propagated to the user by air. However, an impedance of the air and an impedance of the body differ substantially. Therefore, the external sound is hardly propagated to the inside of the body.

For this reason, the external sound is hardly detected by the microphone that picks up efficiently the sound in the body. In other words, it is possible to make a judgment of whether or not the user U is uttering depending on whether or not the voice detected by the microphone picking up efficiently the sound in the body is detected to have a power of more than a predetermined level.

Furthermore, for improving a judgment accuracy, the user U wears a microphone which picks up efficiently the external sound, and a power detected by this microphone (power B) and a power detected by the microphone which picks up efficiently the sound in the body (power A) are compared. When the user U utters, the power B is comparatively higher than the power A, and when the external sound is entered, the power B is comparatively lower than the power A. Therefore, the power B is divided by power A, and when the resultant value is higher than a predetermined value, the user U can be judged with high accuracy to be uttering, and when the resultant value is lower than the predetermined value, the user U can be judged with high accuracy to be in a non-uttering state.

In this case, the predetermined value depends on as to what type of a microphone is to be used and by what type of an amplifier a signal is to be amplified, and the optimum value changes. Practically; it is better to find the optimum value by an experiment in which the user U is asked to wear the mic, and the power is measured while the user is let to utter.

Here, an example of the microphone which picks up efficiently the sound in the body is a microphone in which a vibration plate of the microphone is in direct or indirect contact with the body, or a microphone having a shape of an earphone used by inserting a sound absorbing section in a middle ear cavity, or other bone conduction microphone.

(Description of Display Mode)

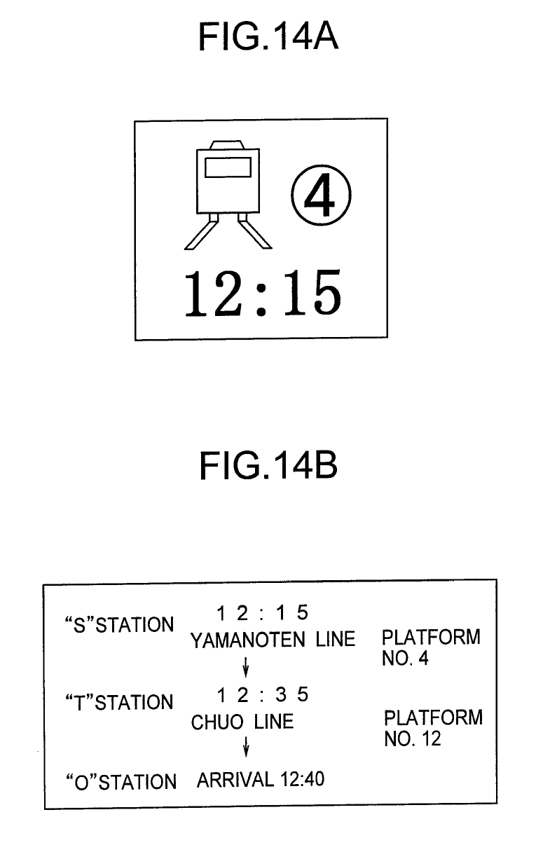

The display mode in the display panel 103 includes at least a brief display mode and a detail display mode. FIG. 14A shows an electronic image displayed on the display panel 103 in the brief display mode. Moreover, FIG. 14B shows an electronic image displayed on the display panel 103 in the detail display mode. The user U using the MEG 150 can perceive the electronic image shown in FIG. 14A or FIG. 14B.

In the brief display mode in FIG. 14A, information “train will start at 12:15 hour from platform number 4” is displayed as an icon display and a number display (character display). Whereas, in the detail mode in FIG. 14B, character information in further details such as “Yamanote line train will start at 12:15 hour from platform number 4 of “S” station”, “Chuo line train will start at 12:35 hour from platform number 12 of “T” station”, and “train will arrive at “0” station at 12:40 hour” is displayed. Switching of the display mode, such as switching from the brief display mode to the detail display mode is performed automatically according to the active state of the user U. A procedure for switching the display mode will be described later.

It is desirable that a lower limit value of a size of display characters in the brief display mode is higher than a lower limit value of a size of display characters in the detail display mode. Accordingly, in the brief display mode, the user U can perceive the information easily by comparing with the detail display mode.

Moreover, when the same information is displayed on the display panel 103, it is desirable that a ratio of number of icons with respect to number of characters included in an electronic image of the display panel 103 in the brief display mode is greater than a ratio of number of icons with respect to number of characters included in an electronic image on the display panel 103 in the detail display mode. For example, in FIG. 14A, the number of icons showing a train is one. Whereas, in FIG. 14B, the number of icons is zero. Accordingly, the user U can perceive the display content easily in the brief display mode, when the same display content is displayed.

Moreover, it is desirable that in the brief display mode; the maximum number of characters displayed in a single screen is less as compared to the maximum number of characters displayed in a single screen in the detail display mode.

Accordingly, the user U can check the content in a short time. In the brief display mode, it is desirable to display information by using a part at a substantial center of the display screen in the detail display mode.

When relative position of the eyepiece window (optical window) with respect to the eye of the user U is shifted from a predetermined position, nearer the display screen which can be observed by the user U, the display screen is more susceptible to be shaded. As it is described earlier, in the brief display mode, by displaying the information by using only a part of the substantially central portion of the display screen in the detail display mode, even if the relative position of the eyepiece window (optical window) with respect to the eye of the user U is somewhat shifted, the user U can perceive the displayed information without missing any information.

Due to the vibrations and movement of face muscles, the relative position of the eyepiece window (optical window with respect to the eye of the user is susceptible to move from a predetermined position. However, when in the brief mode, the display screen is not shaded.

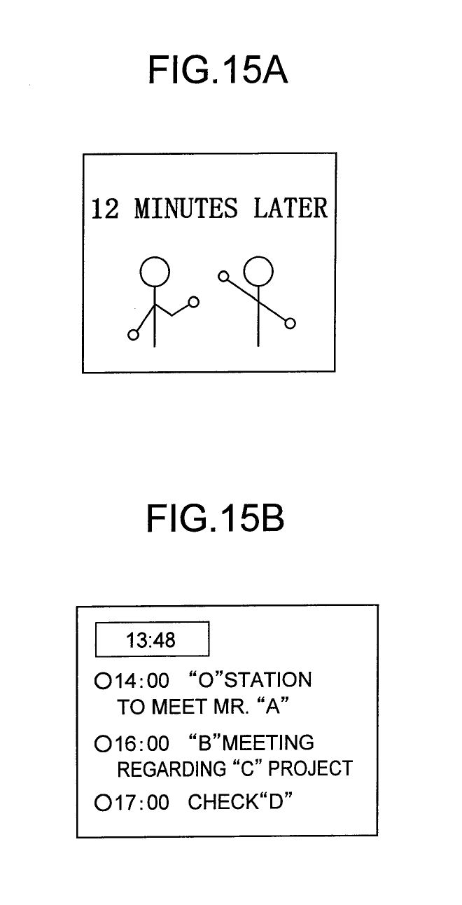

FIG. 15A and FIG. 15B show a second example of display in the brief display mode and the detail display mode respectively. In the brief display mode, information “12 minutes later a meeting with a specific person has been scheduled” is displayed by character information and icon. With respect this information, in the detail display mode, detail character information “13:48 hour” (present time), “to meet Mr. A at 14:00 hour at “O” station”, “meeting “B” regarding project “C” to be held at 16:00 hour”, and “check D at 17:00 hour” is displayed.

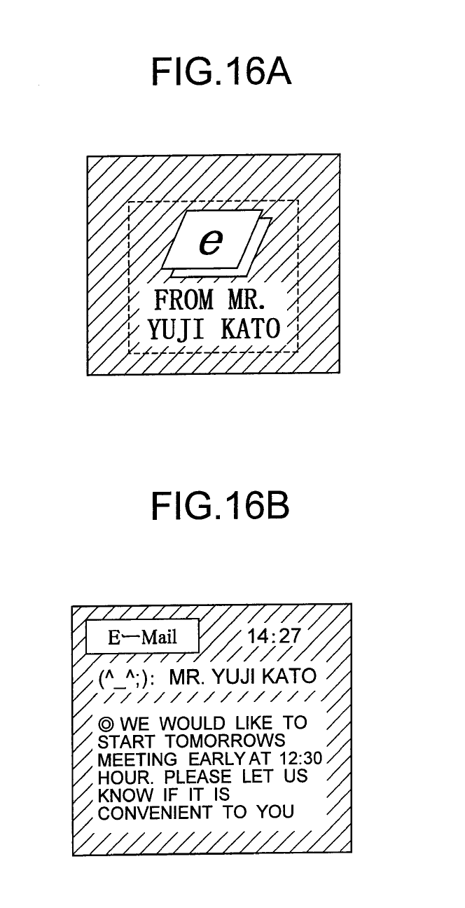

FIG. 16A and FIG. 16B show a third example of display in the brief display mode and the detail display mode respectively. In the brief display mode, by using only a part of the central portion of the display screen (portion surrounded by dashed lines in FIG. 16A, information “e-mail has come from Mr. Kato” is displayed as character information and icon.

With respect to this, in the detail display mode, information “time of sending e-mail”, “present time”, “sender's name”, and “message body” is displayed as detail information by using the entire display screen. However, in this example, a scenic screen mainly for decorative purpose (hatched portion in FIG. 16A and FIG. 16B) is displayed by using the entire screen both in the brief display mode and the detail display mode.

### (Description of Field and Item)

A field and an item will be described by using the third example described above. A frame storing each of “time of sending e-mail”, “present Time”, “sender's name”, and “message body” is a field, and data stored in the frame is an item. A bundle of plurality of fields is called a record. For example, information of one e-mail is accommodated in one record. In this record, there exists a plurality of fields, and data such as “Tsuneo Kato” or “Kazuko Sasaki”, in other words items, are stored in a field in which “sender's name” is input.

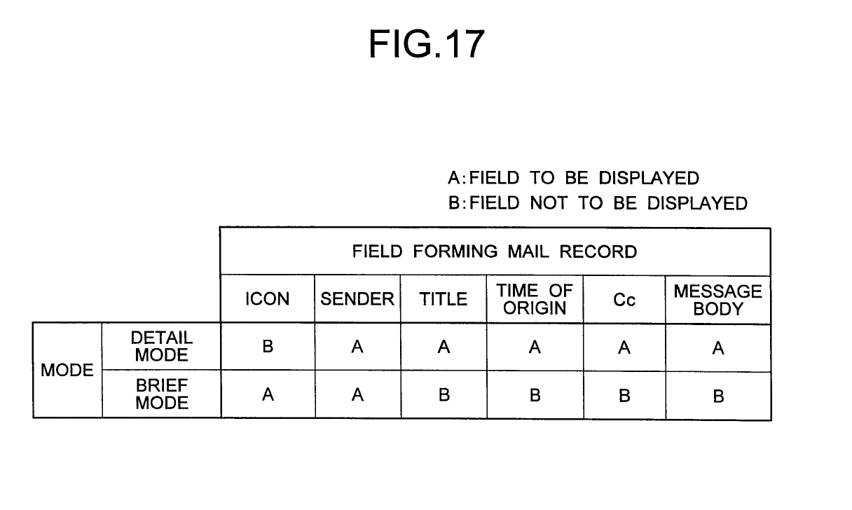

FIG. 17 shows as to how the information “e-mail has come from Mr. Kato” is to be displayed according to the active condition of the user U. In FIG. 17, “A” shows a field to be displayed and “B” shows a field not to be displayed. Moreover, as an active state of the user U, four states “not walking”, “walking”, “not uttering”, and “uttering” can be considered.

A content of the electronic image to be displayed on the display panel 103 is formed by each of the plurality of fields. In this example, information related to the e-mail includes six types of fields namely “icon”, “sender”, “title”, “time of origin”, “Cc” and “message body”.

When the active state of the user U is judged to be “not walking” by a detection result from the acceleration sensor described above, the display mode is automatically switched to the detail mode. Furthermore, according to a table shown in FIG. 17, that item is selected from display fields “sender”, “title”, “time of origin”, “Cc”, and “message body”. As a result of this, as shown in FIG. 16B, detail character information is displayed by using the entire screen.

Whereas, when the active state of the user U is judged to be “walking” by a detection result from the acceleration sensor, the display mode is automatically switched to brief mode. Furthermore, according to the table shown in FIG. 17, that item is selected from the display fields “icon” and “sender”. As a result of this, as shown in FIG. 16A, only the icon and the sender's name are displayed by using a part of the central portion of the screen with characters of size larger than the size of characters in the detail mode.

When, the active state of the user U is judged to be “not uttering” or “uttering” by a detection result from the microphone which picks up efficiently the sound in the body, the mode is switched to the detail mode and the brief mode, and similarly as in the active state of “not walking” and “walking”, an icon according to the table shown in FIG. 17 is selected and displayed.

Moreover, in this example, it is desirable that when the active state of the user U is at least any one of “not walking” (when not walking), gazing at electronic image, and “not uttering” (when not uttering), the display mode is automatically switched to the detail mode. When the user U is not walking, gazing at the electronic image, and not uttering, the user U can concentrate on perceiving information which is displayed in a field of view of each naked eye. Accordingly, it is possible to perceive detail information.

Moreover, it is desirable to prohibit a scroll display in the brief display mode and to allow a scroll display in the detail display mode. Accordingly, in the detail display mode, entire information can be perceived by scrolling.

Furthermore, it is desirable that the display mode at least has a non-display mode, and that the display mode is automatically changed to the non-display mode when the active state of the user is “walking”, “not gazing at electronic image”, or “uttering”. Accordingly, when the user is “walking”, “not gazing at electronic image”, or “uttering”, the display is put OFF. Therefore, it is possible to prevent negligence in other action on part of the user U caused due to concentration on perceiving the display of the electronic image.

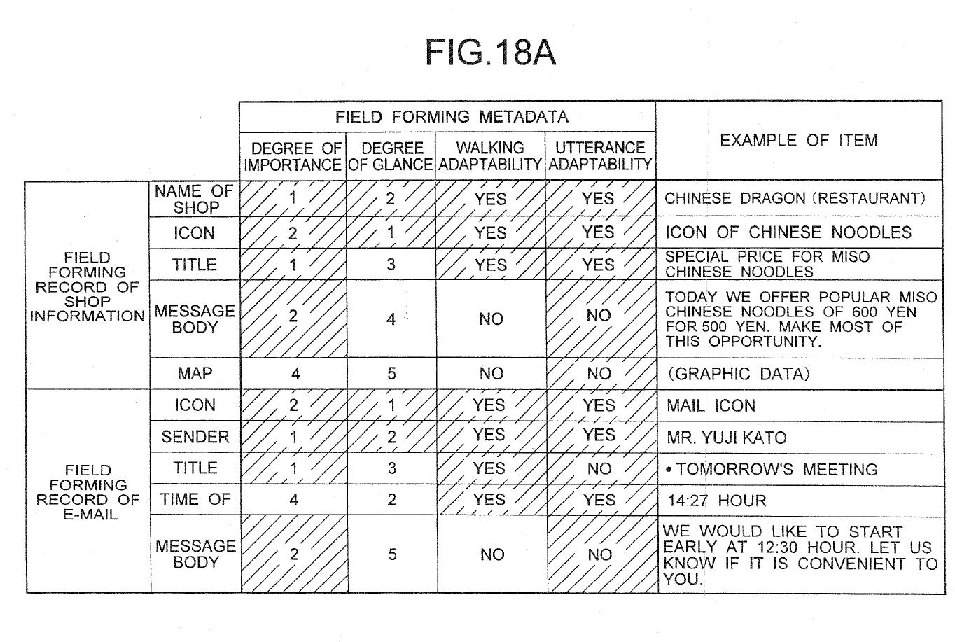

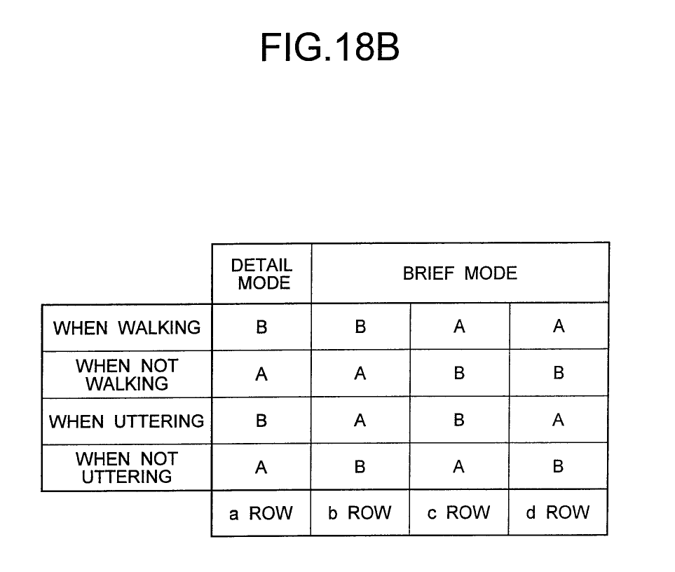

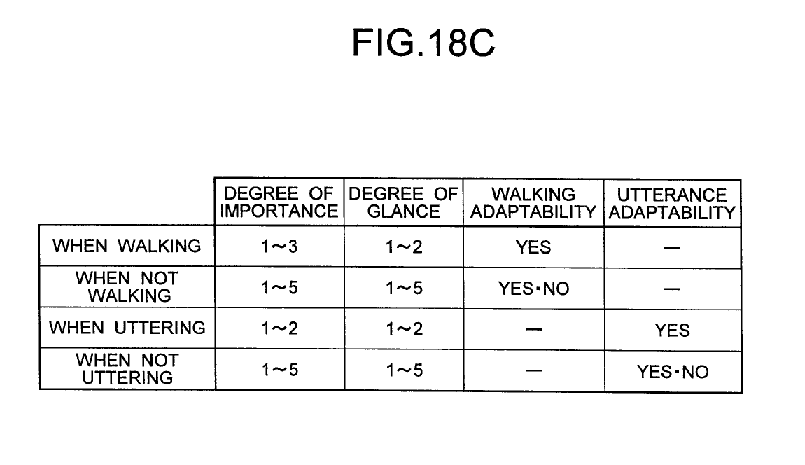

Other examples will be shown by using FIG. 18A, FIG. 18B, and FIG. 18C. In this example, a case of displaying the record of shop information and e-mail information is assumed. FIG. 18A shows metadata assigned to each field, and item recorded in each field in advance. Metadata is data which show characteristics of a record or a field. FIG. 18B shows a display mode determined in advance to which the display mode is to be switched automatically for a combination of the walking state and the utterance state. FIG. 18C shows as to which field having which metadata is to be displayed with respect to the active state.

In FIG. 18B, cases when A is applicable and cases when B is not applicable respectively are shown. For example, in a case of walking and not uttering, in FIG. 18B, when walking and not uttering, A is assigned, which is example C, and the display mode is switched automatically to the brief mode.

Furthermore, in FIG. 13C, a degree of importance when walking, is 1 to 3, and when not uttering, the degree of importance is 1 to 5. Further, a field having metadata of the degree of importance 1, 2, and 3 which satisfy both conditions is subjected to display.

Similarly, a degree of glance when walking, is 1 to 2, and when not uttering, the degree of glance is 1 to 5. Further, a field having metadata of degree of glance 1 or 2 which satisfy both conditions is subjected to display. Further, in this case, a field having the metadata in which a walking adaptability “yes”, and an utterance adaptability “yes” or “no” is displayed.

Summing up once again, a field having the metadata which has the degree of importance 1 or 2 or 3, the degree of glance 1 or 2, a walking adaptability “yes”, and an utterance adaptability “yes” or “no” is displayed.

In FIG. 18A, when the field having these metadata is checked, it can be seen that in the shop information record, the field of the icon and the shop name corresponds to the field of the sender and the icon in the e-mail record.

Consequently, as the shop information when walking and not uttering, “Chinese Dragon” which is an item recorded in a field shop name and “icon of Chinese noodles” which is recorded in the icon field are displayed. Similarly, in e-mail, “mail icon” and “Yuji Kato” are displayed in a part of the central portion of the screen.

### (Modified Embodiment of Information Display System)

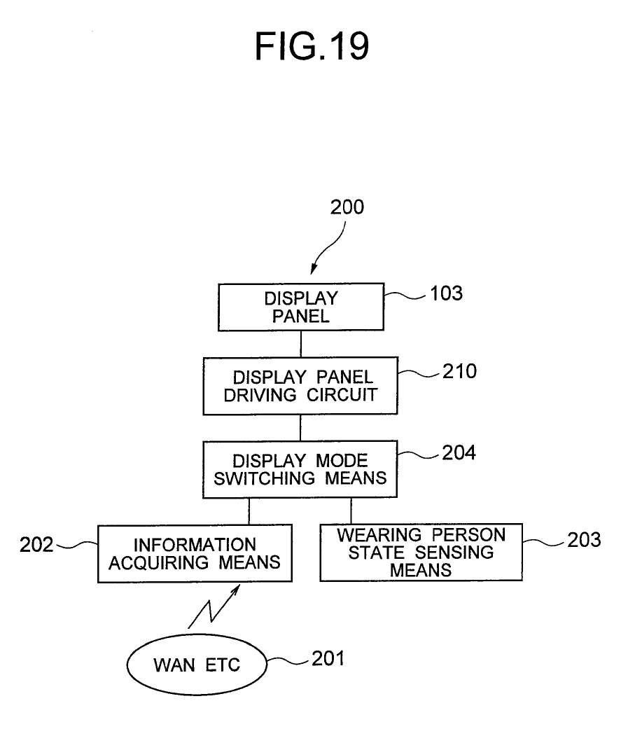

FIG. 19 is a block diagram showing a function of an information display system 200 according to a modified embodiment. The same reference numerals are used for components which are same as in the information display system 100 and description of the same components is omitted. The information display system 100 includes two main components the MEG 150 and the portable unit 250. Whereas, in the modified embodiment, a function of a portable unit as an information processing module is incorporated in an MEG. Therefore, the user U may wear only the MEG.

### (Automatic Switching of Display Mode)

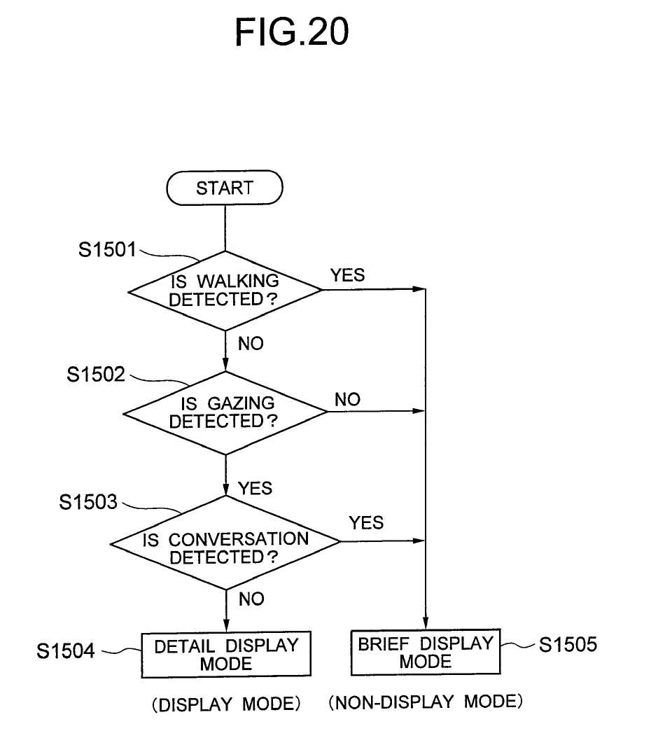

A procedure for switching automatically the display mode according to the active state of the user U will be described below. FIG. 20 is a flowchart showing a procedure for switching the display mode. At step S1501, a judgment of whether the user U is walking is made based on a detection result of a sensor such as the acceleration sensor. When the judgment result is “Yes”, at step S1505; the display mode is let to be the brief display mode. When the judgment result at step S1501 is “No”, the process is advanced to step S1502.

At step S1502, a judgment of whether the user U is gazing an electronic image on the display panel 103 is made based on a detection result from a sensor such as the infrared ray sensor. When a judgment result is “No”, at step S1505, the display mode is let to be the brief display mode. When the judgment result at step S1502 is “Yes”, the process is advanced to step S1503.

At step S1503, a judgment of whether the user U is uttering is made based on a detection result from the microphone which picks up efficiently the sound in the body. When a judgment result at step S1503 is “Yes”, at step S1505, the display mode is let to be the brief display mode. When the judgment result at step S1504 is “No”, at step S1504, the display mode is let to be the detail display mode. The brief display mode may be let to be “non-display mode” and the detail display mode may be let to be “display mode”.

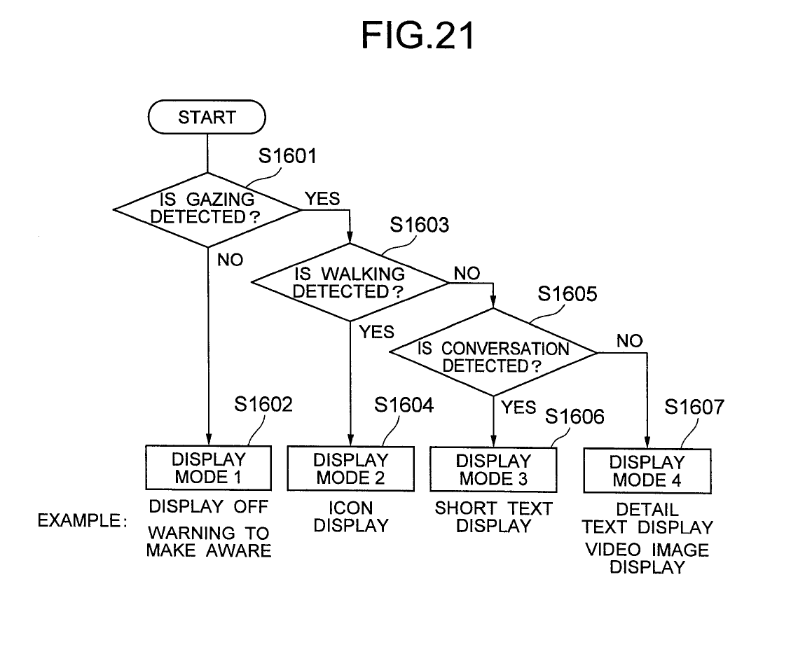

FIG. 21 is a flowchart showing another procedure for switching the display mode. At step S1601, a judgment of whether the user U is gazing at the electronic image is made based on the judgment result from a sensor such as the infrared ray sensor. When a judgment result is “No”, at step S1602, the display mode is let to be a display mode 1. In the display mode 1, the display is let to be OFF, and a warning to make the user U aware is given. Moreover, when the judgment result at step S1601 is Yes, the process is advanced to step S1603.

At step S1603, a judgment of whether the user U is walking is made based on the judgment result of a sensor such as the acceleration sensor. When a judgment result is “Yes”, at step S1604, the display mode is let to be a display mode 2. The display mode 2 performs a display by an icon for example. When the judgment result at step S1603 is “No”, the process is advanced to step S1605.

At step S1605, a judgment of whether the user U is uttering is made based on the detection result of the microphone which picks up efficiently the sound in the body. When a judgment result at step S1605 is “Yes”, at step S1606, the display mode is let to be a display mode 3. In the display mode 3, a short text for example, is displayed. When the judgment result at step S1605 is “No”, at step S1607, the display mode is let to be a display mode 4. In the display mode 4, a detail text or a video image for example is displayed.

### Second Embodiment

An information display system according to a second embodiment of the present invention will be described. The same reference numerals will be used for components same as in the first embodiment, and description of these components will be omitted.

The information display system according to the second embodiment has the same structure as the information display system shown in FIG. 10. As shown in FIG. 10, the MEG 150 is driven by a battery 211, and includes the wireless receiving means 208 which is capable of at least receiving. The MEG 150 corresponds to a head-mount unit. Moreover, the timer 207b, the wireless receiving means, and the received data processing circuit 209 correspond to a first wireless communication module C1.

Furthermore, the wireless transmitting means 206 is structured separately from the MEG 150, and can perform at least transmission to the wireless receiving means 208. The transmission data translating circuit 205, the wireless transmitting means 206, and the timer 207a correspond to a second wireless communication module C2.

The wireless receiving means 208 is started up from a stand-by state after elapsing of a predetermined time or at a predetermined time by the timer 207a which is integrated therein. Furthermore, the wireless receiving means 208 returns to the stand-by state after completion of receiving signal transmitted from the wireless transmitting means 206. Accordingly, the wireless receiving means 208 is prevented from being started-up after completion of receiving the signal transmitted from the wireless transmitting means 206. Therefore, it is possible to save electric power.

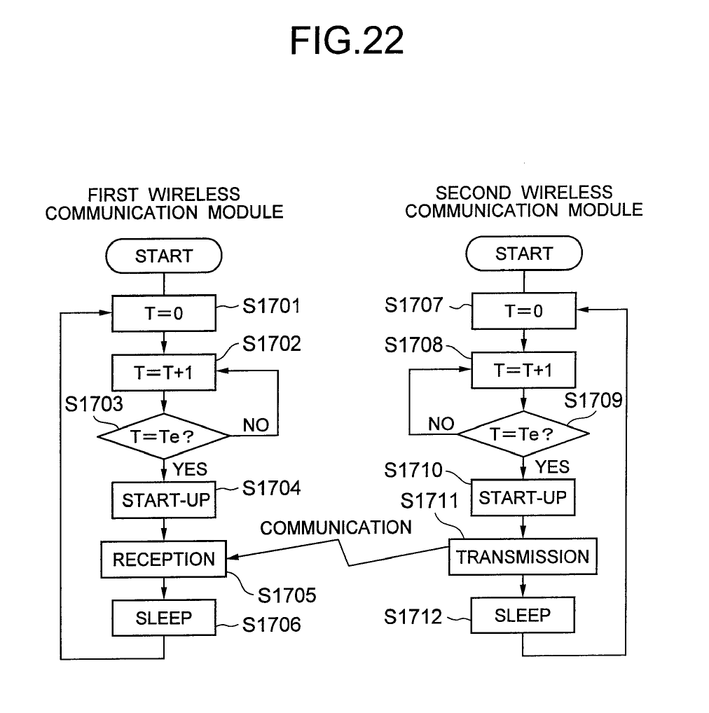

FIG. 22 is a flowchart showing a procedure during transmission and receiving. At step S1701, a time T is set to zero (T=0) at the first wireless communication module C1. At step S1702, T is let to be T+1 (T=T+1). At step S1703, a judgment of whether T=Te is made. When a judgment result is “No”, the process is returned to step S1702. When the judgment result at step S1703 is “Yes”, at step S1704, the first wireless communication module C1 is started up. At step S1705, the first wireless communication module C1 receives a signal from the second wireless communication module C2. Further, at step S1706, after completion of receiving the signal, the first wireless communication module C1 goes into a stand-by state.

Moreover, at step S1707, a time T is set to zero (T=0) in the second wireless communication module C2. At step S1708, T is let to be T+1 (T=T+1). At step S1708, a judgment of whether T=Te is made. When a judgment result is “No”, the process is returned to step S1708. When the judgment result at step S1709 is “Yes”, at step S1710, the second wireless communication module C2 is started up. At step S1711, the second wireless communication module C2 transmits a signal to the first wireless communication module C1. Further, at step S1712, after completion of receiving the signal, the second wireless communication module C2 goes into the stand-by state.

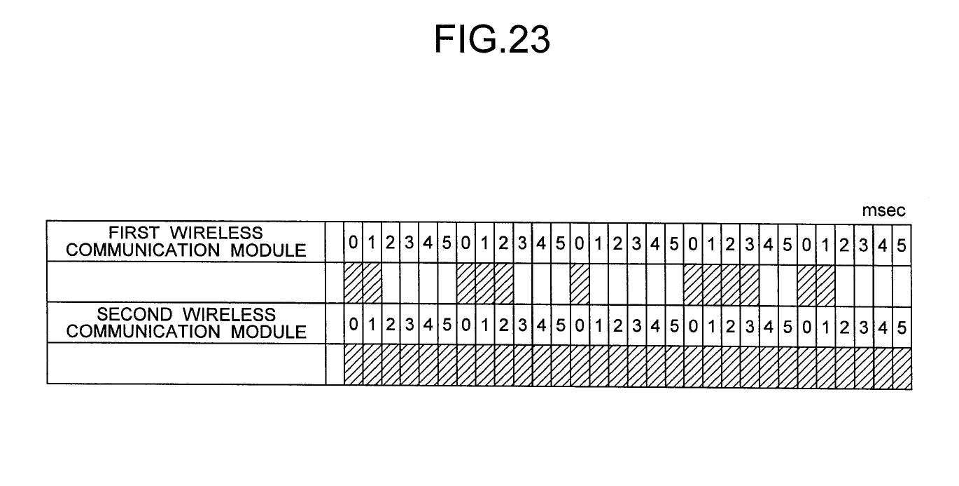

FIG. 23 shows timings of communication. FIGS. 0, 1, 2, 3, 4, and 5 in an upper line in FIG. 23 show time elapsed. A unit is msec for example. Moreover; in FIG. 23, a state of the transmission or the reception being performed is shown by a hatched portion, and a state of the transmission or the reception not being performed is shown by white color portion.

As it is evident from FIG. 23, even when the time required for communication is varied and the start-up time of the first wireless communication module is varied, looking at start-up timing, the timing can be set to be constant all the time, such as every 5 msec for example.

Moreover, the wireless transmitting means 206 is started up by the integrated timer 207a from the stand-by state after elapsing of the predetermined time, or at the predetermined time. Furthermore, it is desirable that the wireless receiving means 208 and the wireless transmitting means 206 are started up simultaneously from the stand-by state, and perform communication.

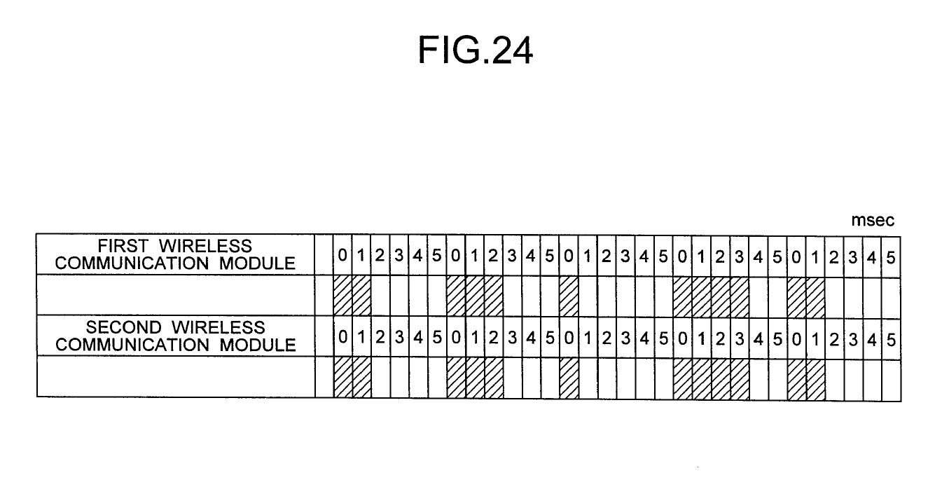

FIG. 24 shows a timing of communication after the start-up. The two timers 207a and 207b can be synchronized mutually by a principle of a wave clock for example.

Moreover, it is desirable that a predetermined time or a predetermined hour or a clock time is set in the timers 207a and 207b which are integrated in the wireless receiving means 208 and the wireless transmitting means 206 respectively, by transmitting from the wireless receiving means 208 to the wireless transmitting means 206, or from the wireless transmitting means 206 to the wireless receiving means 208. Thus, in the second embodiment, the information display system is structured to enable mutual transmission and reception between the wireless receiving means 208 and the wireless transmitting means 206.

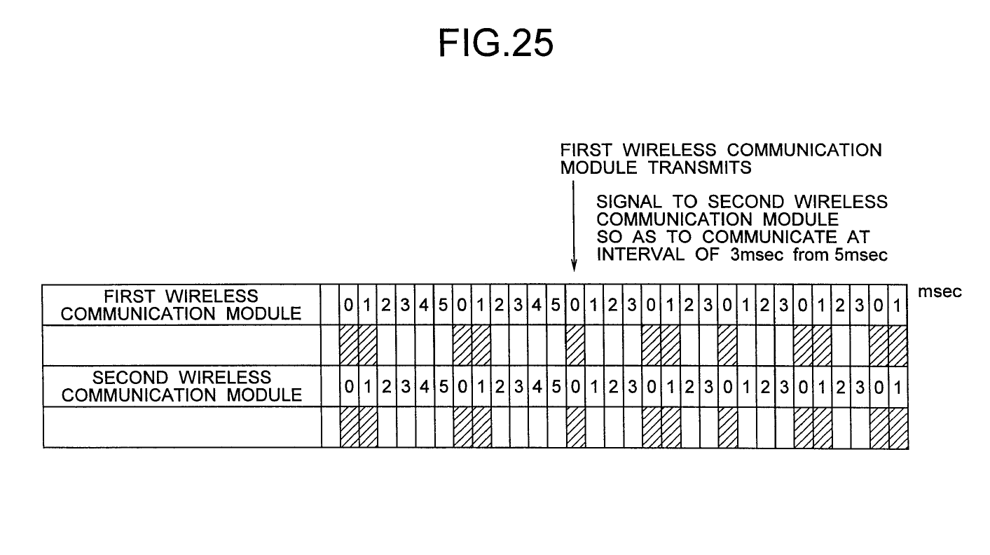

FIG. 25 shows communication timings when the signal is transmitted and received between the wireless receiving means 208 and the wireless transmitting means 206. For example, for performing the communication at an interval of 3 msec from 5 msec, the first wireless communication module C1 transmits a signal to the second wireless communication module C2, and the timers 207a and 207b are synchronized.

Moreover, at least one of the timer 207b integrated in the wireless receiving means 208 and the timer 207a integrated in the wireless transmitting means 206 transmits hour (clock time, time) data to the other timer. Furthermore, it is desirable that the timer which has received the time data matches the timer hour (clock time) of the other timer with the time data received, based on the time data which is received. Accordingly, it is possible to match easily the hour (clock time) of the timers 207a and 207b.

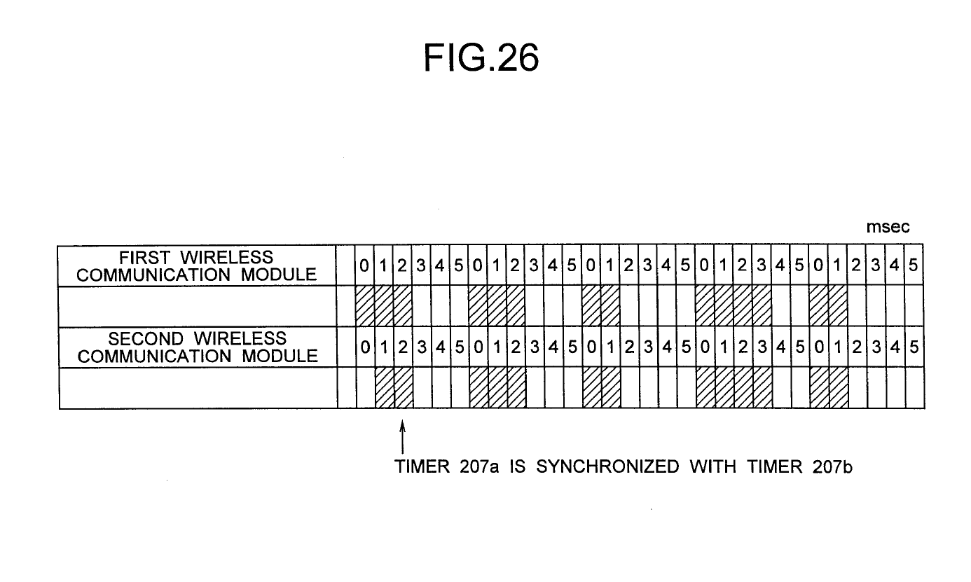

FIG. 26 shows timings of communication when the time of the two timers is matched. For example, the timer 207a is synchronized with the timer 207b when 2 msec have elapsed from the first start-up.

Moreover, at least one of the wireless receiving means 208 and the wireless transmitting means 206 continues to be in the start-up state for a predetermined time longer than a predetermined time of the other till the first communication with the transmission counterpart is performed. Furthermore, it is desirable to synchronize the timers 207a and 207b by a communication when the communication with the counterpart is established.

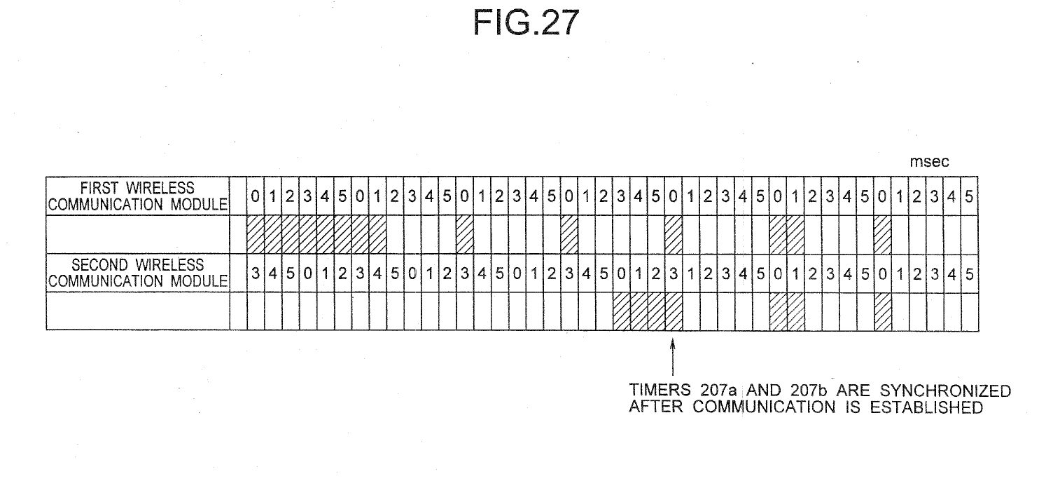

FIG. 27 shows timings of communication when the communication is established. For example, the first wireless communication module C1 on the MEG 15 side is assumed to be a side which repeats the start-up and stand-by at predetermined time. First of all, the user U asked to put a power supply ON from the first communication module on the MEG 150 side, and then, a power supply of the second wireless communication module on the portable unit 250 side. At this time, if the second wireless communication module C2 maintains the start-up state for a time of one cycle, in other words, a predetermined cycle time required for the stand-by and start-up of the first wireless communication module C1, the first wireless communication module performs the start-up during this time without fail. Accordingly, the communication can be started between the first wireless communication module C1 and the second wireless communication module C2.

As shown in FIG. 27, after the communication is established between the first wireless communication module C1 and the second wireless communication module C2, it is possible to have synchronization between the timers 207a and 207b. Moreover, the first wireless communication module C1 and the second wireless communication module C2 may be interchanged mutually (reversed).

Both the wireless communication modules for the wireless receiving means 208 and the wireless transmitting means 206 continue to be in the start-up state only for a predetermined time T2 of the other which is longer than a predetermined time T1, till the first communication with the transmission counterpart side is performed. Next, the timers 207a and 207b are synchronized by the communication when the communication is established with the counterpart side. Further, when each of the timers is synchronized, or when the communication is not established during the predetermined time T2 of the other which is longer than the predetermined time T1, it is desirable that both the wireless communication modules of the wireless receiving means 208 and the wireless transmitting means 206 repeat the stand-by state and the start-up state at a cycle of the predetermined time T1.

For example, out of the first wireless communication module C1 and the second wireless communication module C2, one module for which the power supply is put ON first, enters a mode of repeating the stand-by and start-up at a predetermined cycle T1, as long as the power supply of the remaining module is not put ON quickly. Thereafter, the module for which the power supply is put ON later, enters a state in which the power supply is put ON continuously during the predetermined time T2 of the other module. Furthermore, after the communication is established between the first wireless communication module C1 and the second wireless communication module C2, it is possible to have synchronization between the timers 207a and 207b.

In the second embodiment, furthermore, it is desirable to use a non electric power saving mode and an electric power saving mode. The non electric power saving mode and the electric power saving mode are switched automatically according to the active state of the user U. Accordingly, it is possible to perform efficiently the electric power saving.

Here, in the electric power saving mode, the wireless receiving means 208 is started up from the stand-by state at a predetermined hour after elapsing of the predetermined time or at a predetermined time, by the timer 207b. Moreover, the wireless receiving means 208 is returned to the stand-by state after the completion of receiving signal transmitted from the wireless transmitting means 206. Further, in the non electric power saving mode, the wireless receiving means is always in the start-up state.

In the electric power saving mode and the non electric power saving mode, the wireless receiving means 208 is started up from the stand-by state by the timer 207b integrated in the wireless receiving means 208, at a predetermined hour after elapsing of the predetermined time or at a predetermined time. Furthermore, the wireless receiving means 208 is returned to the stand-by state after completion of receiving the signal transmitted from the wireless transmitting means. It is desirable that the stand-by time of the wireless receiving means 208 is set automatically to be longer than the predetermined time or the predetermined hour in the non electric power saving mode.

Accordingly, the communication with the second wireless communication module C2 is performed frequently with the stand-by time of the first wireless communication module C1 to be shorter in the non electric power saving mode as compared to the electric power saving mode. For example, in the non electric power saving mode, communication is performed once per minute, and in the electric power saving mode, the communication is performed once per hour.

Further, the active state of the user U which is a judgment criterion for as to which mode out of the non electric power saving mode and the electric power saving mode to be shifted to, is a state of whether or not the user U is walking. Whether or not the user U is walking is detected by at least any one of the acceleration sensor, the inclination sensor, the angular velocity sensor, the vibration sensor, the heart-beat sensor, and the GPS held by or worn by the user U. Based on a detection result from these sensors, the mode can be switched efficiently to any one of the non electric power saving mode and the electric power saving mode.

Moreover, another example of the active state of the user U is a state of as to whether the user is gazing at the electronic image on the display panel 103 or not. As to whether or not gazing at the electronic image can be detected by combining the infrared ray irradiating means and the infrared ray sensor. The infrared ray irradiating means irradiates infrared rays on the eyeball E of the user U. The infrared ray sensor detects infrared rays reflected from the eyeball E. Accordingly, it, is possible to detect whether the user U is gazing at the display panel 103 or not. Further, when the user U is judged to be gazing at the electronic image, the mode is shifted to the non electric power saving mode. Moreover, as described above, as to whether or not the user is gazing at the electronic image can be detected by the myoelectric potential sensor.

Another example of the active state of the user U which is a judgment criterion for as to which mode out of the non electric power saving mode and the electric power saving mode to be shifted to, is a state of whether or not the user is uttering. The state of uttering of the user U can be detected by the microphone worn by the user U, which picks up efficiently the sound in the body. When the user U is judged not to be uttering, the mode is shifted to the non electric power saving mode.

### Third Embodiment

Next, an information display system according to a third embodiment of the present invention will be described below. The information display system according to the third embodiment displays the display of the electronic image in various modes by detecting whether or not the user is gazing at the electronic image.

A structure of the information display system according to the third embodiment being same as the structure of the information display system described in the first embodiment, the description is omitted to avoid-repetition. As described earlier, the infrared ray sensor and the myoelectric potential sensor detect whether or not the user is gazing at the electronic image. Further, the display mode switching means 204 outputs a signal for performing the display as will be described below, according to the detection result.

In the third embodiment, when the user U is judged not to be gazing at the electronic image on the display panel 103, the display panel 103 displays repeatedly the predetermined information at a predetermined cycle. Whereas, when the user U is judged to be gazing at the electronic image on the display panel 103, the repeated display on the display panel 103 is stopped.

It is desirable to call user's attention to the electronic image when the user is not gazing at the electronic image. For this, the display panel 103 displays predetermined information repeatedly ON and OFF with a predetermined cycle. When, the user U has gazed the electronic image, the repeated display is stopped.

Moreover, when the user U is judged not to be gazing at the electronic image, the display panel 103 displays the information with a predetermined cycle. Whereas, when the user U is judged to be gazing at the electronic image, it is desirable that the cycle with which the information is displayed repeatedly is longer as compared to the predetermined cycle when the user U is not gazing at the electronic image.

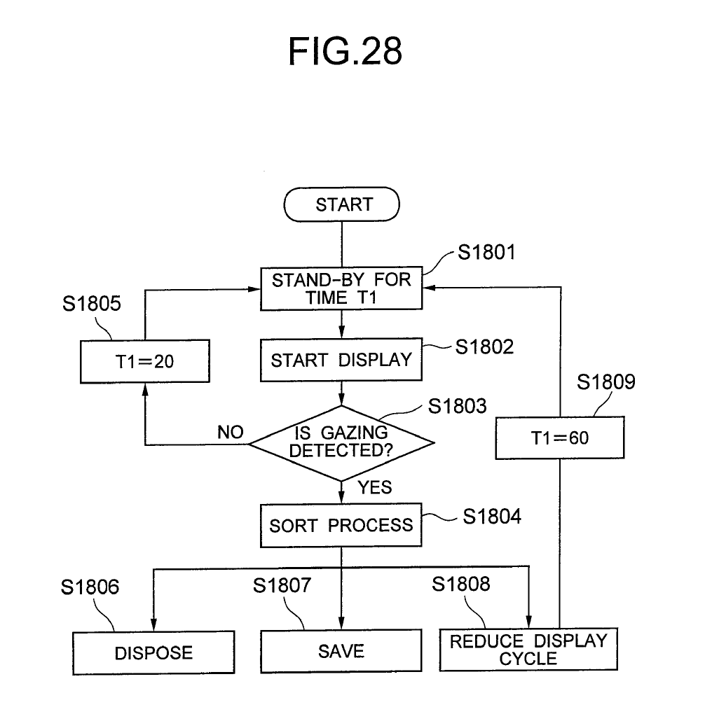

FIG. 28 is a flowchart of a display procedure when a judgment of whether or not the user is gazing at the electronic image is made. At step S1801, the display panel 103 continues to be in the stand-by state only for time T1. At step S1802, the display panel 103 starts display of the electronic image. At step S1803, a judgment of whether or not the user U is gazing at the electronic image is made from a judgment result of the infrared ray sensor. When a judgment result at step S1803 is “No”, at step S1805, T1 is set to 20. Further, the process is returned to step S1801.

When the judgment result at step S1803 is “Yes”, the process is advanced to step S1804. At step S1804, process sorting is performed. The process sorting means setting metadata to a record and to store in a case of mail (step S1807) to dispose in a case of shop information (step S1806), and in other cases to reduce a display cycle of the electronic image (step S1808) for example. After step S1808, at step S1809, time T1 is set to 60 (T1=60), and the process is returned to step S1801.

By such procedure, when the user U is not gazing at the electronic image for example, the display panel 103 displays, once in 20 seconds. Further, when the user U is gazing at the electronic image, the display panel 103 changes the display to once in every 60 seconds. Accordingly, when the user U is not gazing at the electronic image, since the display of the electronic image is put ON and OFF frequently, it is possible to call attention of the user U.

It is desirable that the display panel 103 displays repeated the information with the predetermined cycle till the user U gazes at the display panel 103 for a predetermined number of times by detecting whether or not the user U is gazing at the electronic image. For example, the display panel 103 displays repeatedly with the predetermined cycle till the user U gazes at the display panel 103 for Ne times (where Ne is an integer).

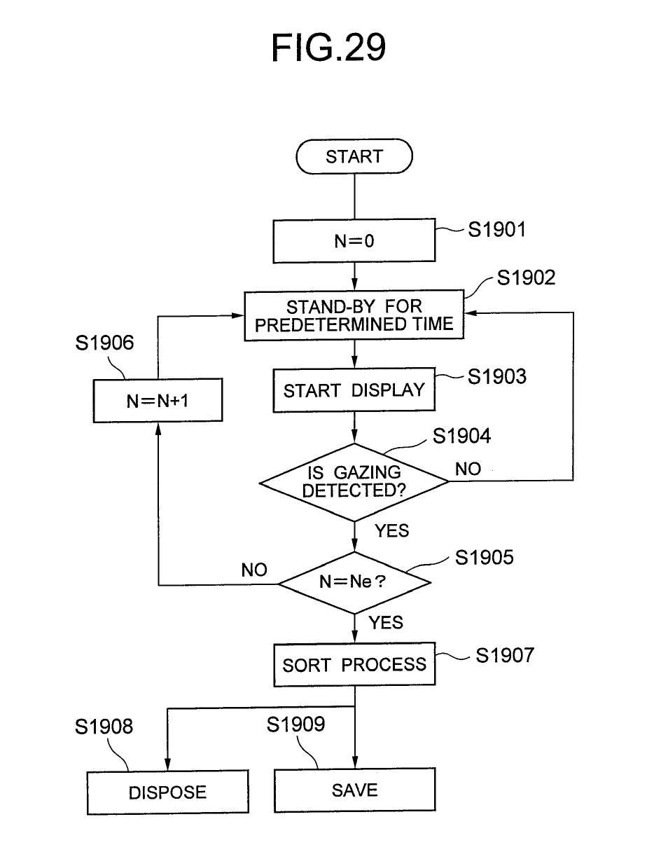

FIG. 29 is a flowchart showing a display procedure of display by the display panel 103. At step S1901, N is set to 0 (N=0). At step S1902, the display panel 103 is at stand-by state for a predetermined time. At step S1903, the display panel 103 starts display of the electronic image. At step S1904, a detection of whether the user U is gazing at the electronic display is made. When a judgment result at step S1904 is “No”, the process is returned to step S1902.

Moreover, when the judgment result at step S1904 is “Yes”, at step S1905, a judgment of whether N=Ne is made. When a judgment result at step S1905 is “No”, at step S1906, N is set to N+1 (N=N+1). Further, the process is returned to step S1902. Moreover, when the judgment result at step 1905 is “Yes”, the process sorting is performed at step S1907. As a result of the process sorting, as described earlier, the mail is saved at step S1909, and shop information is disposed at step S1908 for example.

By detecting whether or not the user U is gazing at the electronic image, when the user U is judged not to be gazing at the electronic image on the display panel 103, the electronic image displayed on the display panel 103 comes to a stationary state. Whereas, when the user U is judged to be gazing at the electronic image, it is desirable to scroll the electronic image displayed on the display panel by moving upward and downward, and to left and to right on the display screen. For example, when the user U has gazed at the electronic image, the display panel 103 moves the icon upward and downward, and to left and to right on the display screen.

By detecting whether or not the user is gazing at the electronic image, when the user U is judged not to be gazing at the electronic image, the display of the display panel goes OFF. Whereas, when the user U is judged to be gazing at the electronic image, the display panel 103 displays information stored in a memory. Accordingly, the MEG 150 can use the electric power efficiently.

Moreover, by detecting whether or not the user is gazing at the electronic image, when the user U is judged not to be gazing at the electronic image, it is desirable to notify a start of information display by a means other than the display panel 103. The start of information display is notified to the user U by at least any one of a sound, vibrations, light introduced from a member other than the display panel 103, and an electric pulse. Accordingly, it is possible to call attention of the user U.

By detecting whether or not the user is gazing at the electronic image, when the user U is judged not to be gazing at the electronic image, the start of the information display may be notified by at least any one of a flashing display of an image, switching of a color of the image, and an alternate display of a positive image and a negative image on the display panel 103. Accordingly, it is possible to call attention of the user U. A control of these displays is performed by a display panel driving circuit.

The information display system according to the third embodiment transmits and receives information intermittently at a predetermined interval between other information transmitting means. When the information is not transmitted and received, it is desirable that the timer performs a time operation (clock operation) for a predetermined time interval. Accordingly, it is possible to save electric power by intermittent communication.

The MEG 150 may include a rolling mechanism which adjusts rotation of a position of the eyepiece window 104. A detailed structure of the rolling mechanism will be described in detail in a fourth embodiment described later. The rolling mechanism can adjust the position of the eyepiece window 104 selectively to any one of a first position and a second position.

Here, the first position is a position substantially at a center of the field of view when the user U looks straight where the electronic image is disposed on the display panel 103. Moreover, the second position is other position different from the first position. When the eyepiece window 104 is at the second position, the information display system 100 transmits and receives information intermittently at the predetermined interval to and from the other information transmitting means. Whereas, it is desirable that when the information is not transmitted and received, the timer performs the time operation (clock operation) for the predetermined time interval, or the information display on the display panel 103 is put OFF. Accordingly, it is possible to save electric power according to the position of the electronic image.

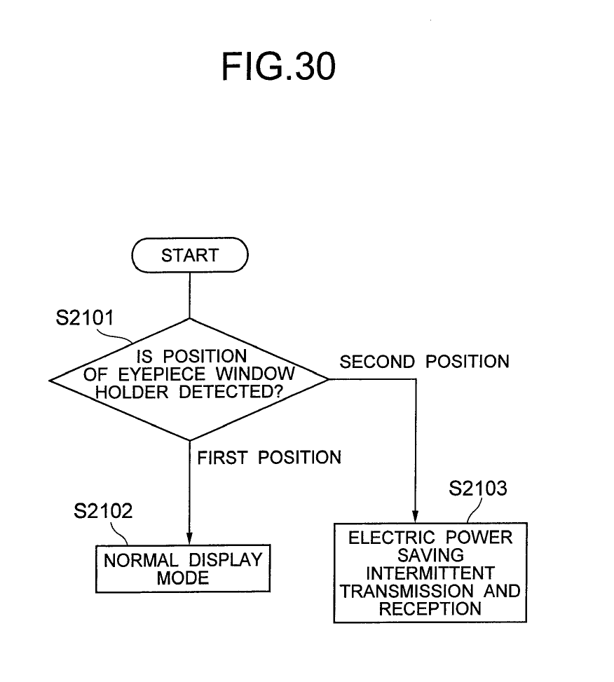

FIG. 30 is a flowchart showing a procedure when saving the electric power according to the position of the electronic image. At step S2101, a position of the eyepiece window holding section 102 is detected. When the eyepiece window holding section is at the first position, at step S2102, the display panel 103 is let to be in a normal display mode. Moreover, when the eyepiece window holding section 102 is at the second position, at step S2103, the mode is let to be the electric power saving mode, and the information is transmitted and received intermittently. Accordingly, the electric power can be saved only by rotating of the eyepiece window holding section 102 by the user U.

In the third embodiment, it is desirable that when the user U is judged to have eyes closed, the information display is let to be OFF.

Furthermore, it is possible to change a size of the display screen of the display panel 103 according to a brightness of the surrounding of the user U.

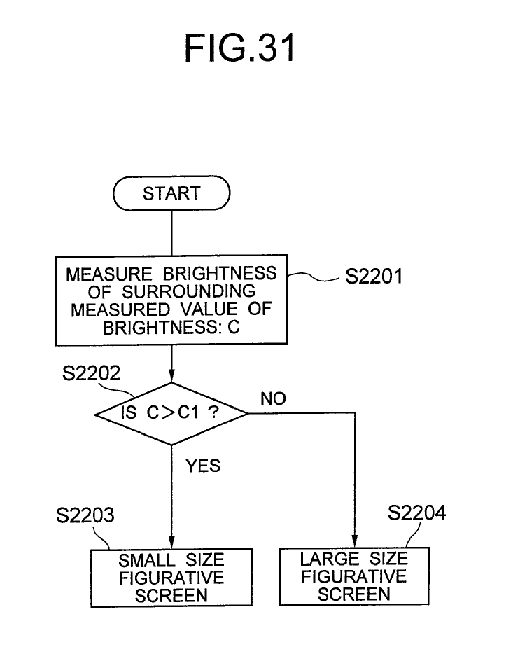

FIG. 31 is a flowchart of a procedure when changing the size of the display screen according to the brightness of the surrounding. At step S2201, brightness of the surrounding of the MEG 150 is measured by using an illumination intensity sensor for example. A measured value of the brightness is let to be C. At step S2202, a judgment of whether C>C1 is made. Value C1 is a threshold value which is determined in advance. When a judgment result is “Yes”, the size of the display screen of the display panel 103 is reduced. Whereas, when the judgment result at step S2202 is “No”, at step S2204, the size of the display screen of the display panel 103 is increased.

The diameter of the human pupil increases in dark surroundings, and decreases in bright surroundings. Therefore, according to the procedure mentioned above, it is possible to perceive a bright electronic image without shading, irrespective of the brightness of the surroundings.

### Fourth Embodiment

Next, an information display system 300 according to a fourth embodiment of the present invention will be described below. Before describing the fourth embodiment, a structure of a conventional head-mount display will be described below. The head-mount display which projects an electronic image having a comparatively larger angle of view is common. Moreover, a head-mount display which includes a mechanism which is capable of changing a relative position of the eyepiece window (optical window) with respect to the eyes of the user by operation by the user has also been proposed (refer to Japanese Patent Application Laid-open Publication No. 2004-304296 for example).

The mechanism in the conventional technology is for adjusting a light beam forming an electronic image, which is emerged from the eyepiece window to be incident on a pupil of eye of the user U, by changing the relative position of the eyepiece window and the eye of the user.

Moreover, when the light beam forming the electronic image, which is emerged from the eyepiece window of the head-mount display, passes appropriately through a pupil of the eye, the electronic image enters into a field of view of the naked eye. This state will be called as “coinciding state of optical axis” for the sake of expediency. Here, this light beam being comparatively thin and a shape of human head and face being varied for each individual, it is not possible to achieve the coinciding state of optical axis only by wearing the head-mount display. Therefore, a mechanism for adjusting as mentioned above is required. For the sake of expediency, such adjustment mechanism will be called as “optical axis adjustment mechanism”

However, when the position of the eyepiece window is changed by using the optical axis adjustment mechanism of the conventional technology, the coinciding state of the optical axis is disrupted. Therefore, the user U cannot perceive the electronic image.

The adjustment mechanism in the fourth embodiment is not provided with an object of achieving the coinciding state of the optical axis mentioned above. The adjustment mechanism in the fourth embodiment is to be used for adjusting as to where in the field of view of the naked eye of the user U to project the electronic image. For the sake of expediency, this adjustment mechanism will be called as “display position adjustment mechanism”. This “display position adjustment mechanism” is a mechanism in which the eyepiece window can be rotated around an axis piercing through a center of rotation f the eye by an operation by the user U.

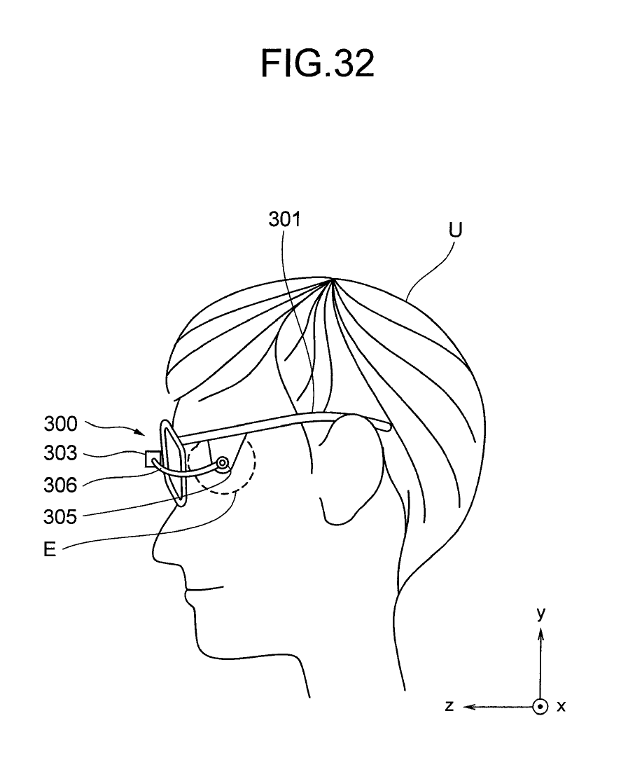

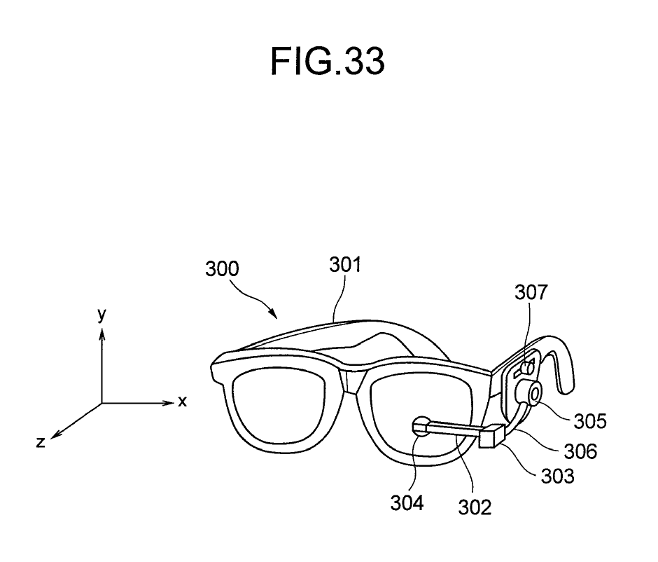

Next, a concrete mechanism of the fourth embodiment will be described. FIG. 32 shows a mechanism as viewed from a side when the user U has worn an information display system 300. FIG. 33 shows a perspective view of the mechanism of the information display system 300.

The information display system 300 is an MEG of a type in which the user U wears spectacles 310. The MEG is fixed to a frame of the spectacles 301 via an adjustment section 307. Next, a mechanism of the MEG will be described.

One of end portions of a supporting section 306 is fixed to be rotatably connected to a rotating section 305. A display panel 303 is formed on other end portion of the supporting section 306. An eyepiece window 304 is held by one of end portions of an eyepiece window holding section 302. The eyepiece window 304 corresponds to an exit window. Further, a display panel 303 is formed on other end portion of the eyepiece window holding section 302. Similarly as in the first embodiment, a reflecting member is provided near the eyepiece window 304.

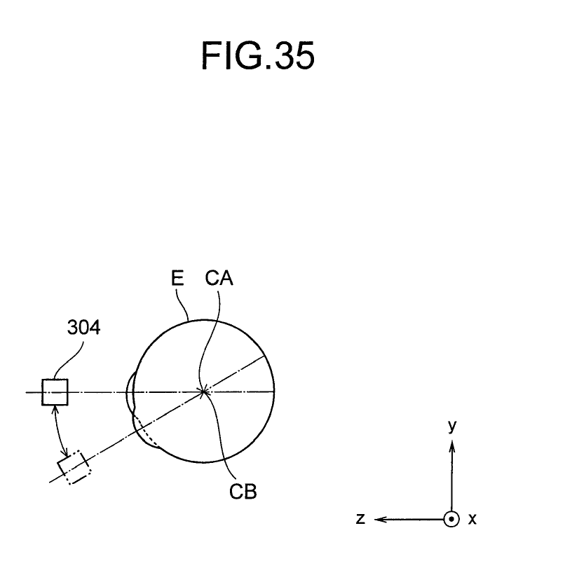

As shown in FIG. 35, a rotation axis CB of the rotating section 305 is disposed to pierce through an area near a center of rotation CA of the naked eye E of the user U. Accordingly, when the supporting section 306 is rotated, the eyepiece window 304 can change the position vertically, but at the same time a direction of the eyepiece window 304 is changed around the rotation axis CB.

First of all, an optical axis of the eyepiece window 304 and an optical axis of the eye are allowed to coincide by some means. In other words, the electronic image is let to be observed clearly without shading (vignetting). This may be performed by arranging an optical axis adjustment mechanism apart from the display-position adjustment mechanism, or by making a display system in which dimensions of the system are optimized by matching with a shape of the head and face of the user. The supporting section 306 in FIG. 32 and FIG. 33, corresponds to the optical axis adjustment mechanism. The supporting section 306 is flexible and has a function of a flexible-joint. The supporting section 306 allows to change freely a position and a direction of the eyepiece window. Therefore, it is possible to allow the optical axis 304 and the optical axis of the eye to coincide by using the supporting section 306.

Next, the display position of the electronic image is adjusted to a desired vertical position by adjusting the position of the eyepiece window 304 by using the display position adjustment mechanism. However, as mentioned above, with this adjustment, since the direction of the eyepiece window 304 is changed around the rotation axis CB, when the eyepiece window 304 with the changed direction is gazed, the optical axis of the eyepiece window 304 and the optical axis of the eye coincide. Therefore, the light beam forming the electronic image which is emerged from the eyepiece window 304 is incident on the pupil of the eye of the user U. In other words, even if the position of projecting the electronic image is adjusted by the display position adjustment mechanism, the sight of the electronic image is not lost. Therefore, the adjustment can be done very easily.

It is also possible to adjust the display position by using only the flexible joint which is the optical adjustment mechanism, and not using such display position adjustment mechanism. However, in this case, coinciding of the optical axis is disrupted according to the adjustment for changing the display position by moving the eyepiece window 304 vertically. Therefore, an adjustment of the coinciding state of the optical axis becomes necessary. However, when the coinciding state of the optical axis is adjusted by moving the flexible joint, with this adjustment, the display position is also changed. Therefore, the adjustment of the display position and the adjustment of the coinciding state of the optical axis are to be performed repeatedly for several times.

In the fourth embodiment, it is desirable that the display mode is switched automatically when the display position of the electronic image is at a predetermined-first area in the field of view of the eye, and at a second area which is different from the first area. Thus, it is possible to adjust the display position of the electronic image by changing the position and the direction of the exit window of the optical system.

A rotary encoder or a switch which is not shown in the diagram is provided around the rotation axis CB around which the supporting section 306 rotates. By detecting a signal from the rotary encoder or the switch, the display mode is switched automatically.

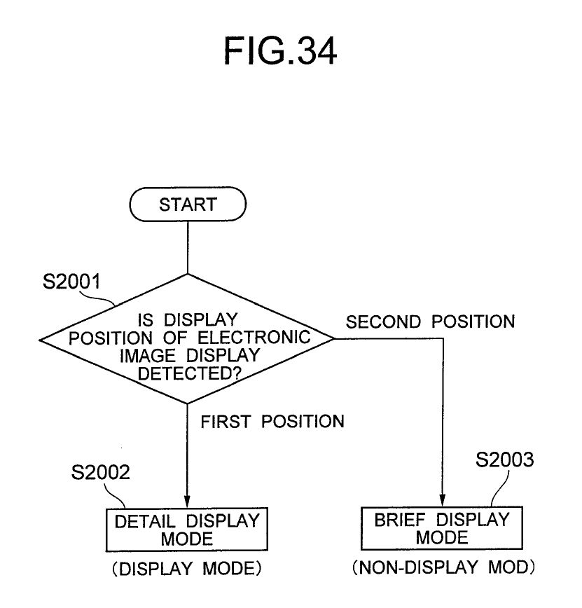

FIG. 34 is a flowchart of a procedure when the display mode is switched automatically. At step S2001, a position of the electronic image is detected. When the position of the electronic image is in the first area, at step S2002, the display mode is let to be the detail display mode (or display mode).

Moreover, when the position of the electronic image is in the second area, at step S2003, the display mode is let to be the brief display mode (or non display mode).

Moreover, in the fourth embodiment, it is desirable that the lower limit value of the size of the display characters in the brief display mode is larger than the lower limit value of the size of the display characters in the detail display mode. Accordingly, the user U can perceive the electronic image more easily in the brief display mode.

Furthermore, when the display panel 303 displays the same information content, it is desirable that the ratio of number of icons with respect number of characters included in the image displayed on the screen of the display panel 304 in the brief display mode is greater than the ratio of number of icons with respect to the number of characters included in the image displayed on the screen of the display panel in the detail display mode. Accordingly, the user U can perceive the electronic image more easily in the brief display mode.

The information display system may be structured such that the scroll display is prohibited in the brief display mode and the scroll display is allowed in the detail display mode.

Content displayed on the display panel 303 is formed by a plurality of records to each of which metadata is assigned. Moreover, metadata is prescribed according to each of the brief display mode and the detail display mode. In each mode, a record to which the prescribed metadata is assigned is selected. Accordingly, it is desirable that the display panel 303 displays content of the selected record. As a result of this, also in the fourth embodiment, similarly as in the embodiments from the first embodiment to the third embodiment, it is possible to switch automatically the display content according to the display mode of the electronic image.

Moreover, it is desirable that in the brief display mode, the maximum number of characters displayed in a single screen is less as compared to the maximum number of characters displayed in a single screen in the detail display mode. Furthermore, in the brief display mode, the information may be displayed by using a part at a substantial center of the display screen in the detail display mode.

Thus, the user U can change the display of the electronic image easily only by changing the position of the eyepiece window 304.

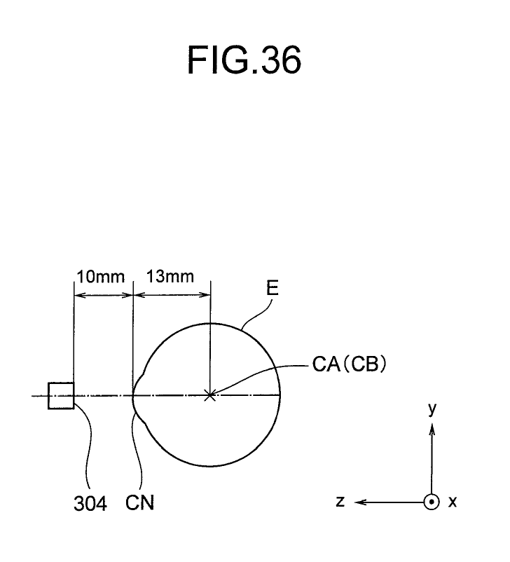

Next, an example of a more concrete structure of the information display system of the fourth embodiment will be described below. As shown in FIG. 36, the rotation axis (central axis) CB of rotation is formed to pierce through the center of rotation CA of the eyeball E, and to coincide substantially. It is preferable that a distance between the eyepiece window 304 of the optical system and the rotation axis CB of rotation is at least 23 mm. Here, a distance from a cornea CN to the center of rotation CA is approximately 13 mm.

Moreover, when the eyepiece window 304 comes closer to the cornea up to 10 mm, eyelashes of the user are susceptible to touch the eyepiece window 304 and the eyepiece window 304 is contaminated. Or, when the user U blinks, eye drops are dispersed and due to the dispersed eye drops, the eyepiece window is susceptible to be contaminated. For these reasons, it is desirable that the eyepiece window 304 and the cornea are separated by at least 10 mm.

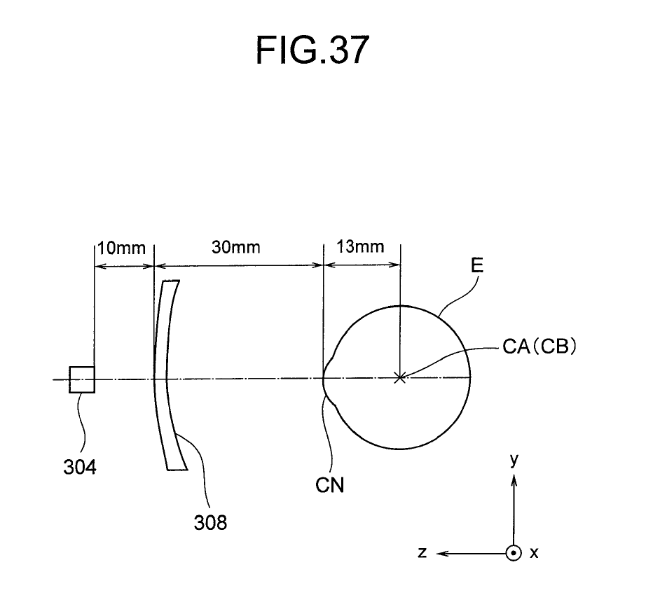

Moreover, as shown in FIG. 37, the distance between the eyepiece window 304 of the optical system and the rotation axis CB of rotation can be let to be not more than 53 mm. In a normal spectacle lens, the spectacle frame is adjusted such that the spectacle lens is 15 mm to 30 mm from the cornea CN. Here, the eyepiece lens 304 is required to be about 10 mm away so that the eyepiece lens 304 does not interfere with the spectacle lens 308 even during rotation. Due to the abovementioned reason, there is a case where it is necessary to ensure the distance up to 53 mm.

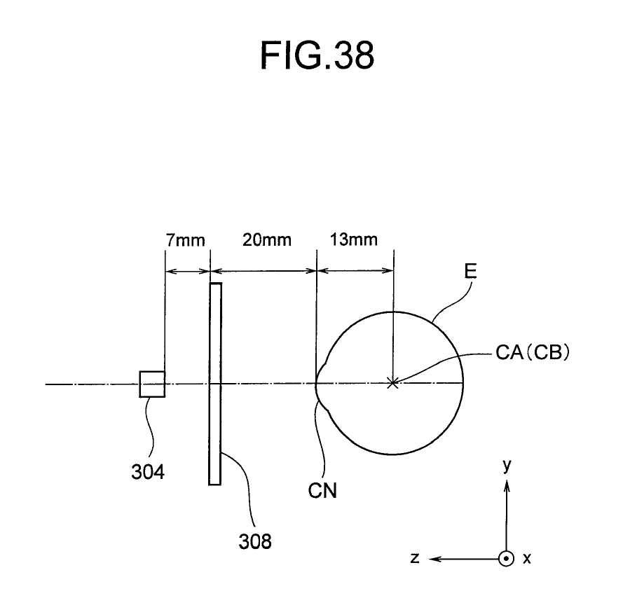

Moreover, as shown in FIG. 38, it is preferable that the distance between the eyepiece window 304 of the optical system and the rotation axis CB of rotation is roughly 40 mm. Farther the eyepiece window 304 from the eye, a size of a limit of the electronic image which can be projected is smaller. Moreover, in many cases the spectacle lens is adjusted to be about 20 mm from the cornea CN. When it is not necessary to have a turning angle of the eyepiece window 304 much large, a distance of about 7 mm may be appropriate for avoiding interference of the eyepiece lens 304 and the spectacle lens.

For the abovementioned reason, when the distance of 40 mm is ensured, even in a case of using the spectacles, the spectacles can be used in most of the cases without any problem. Similar is true for a case of using a protective plate 309 instead of the spectacle lens 308. The protective plate 309 is a transparent plate for avoiding direct interference of the eyepiece window 304 with the cornea CN.

The present invention may have various modified embodiments which fall within the basic teaching herein set forth.

Thus, the information display system according to the present invention is particularly suitable for the information display system which is always worn by the user.

As it is described above, according to the present invention, the display mode of the information display on the display device is switched automatically according to the active state of the user. Accordingly, it is possible to perform the information display appropriate for the active state of the user. Moreover, according to the present invention, the first wireless communication module is started up from the stand-by state after elapsing of a predetermined time or at a predetermined time by the timer integrated into the first wireless communication module, and furthermore, the first wireless communication module is returned to the stand-by state after the completion of receiving the signal transmitted from the second wireless communication module, which is a peculiarity of the present invention. Accordingly, when the first wireless communication module does not perform communication with the second wireless communication module, the first wireless communication module is in the stand-by state. Therefore, it is possible to provide an information display system which can save the electric power efficiently.

1. An information display system comprising at least:
a display device which is wearable on a head of a user; and
a state sensing section which detects an active state of the user;
wherein the state sensing section detects whether or not the user is gazing at an electronic image displayed on the display device, and when the user is judged not to be gazing at the display device, the display device displays predetermined information repeatedly in a predetermined cycle, and when the user is judged to be gazing at the display device, the display device stops the repeated display.

2. An information display system comprising at least:
a display device which is wearable on a head of a user; and
a state sensing section which detects an active state of the user;
wherein the state sensing section detects whether or not the user is gazing at an electronic image displayed on the display device, and when the user is judged not to be gazing at the display device, the display device displays predetermined information repeatedly in a predetermined cycle, and when the user is judged to be gazing at the display device, the display device displays information repeatedly in a cycle, which is longer than the predetermined cycle when the user is not gazing at the electronic image.

3. An information display system according to claim 1, wherein:
the display device displays the information in a predetermined cycle until the state sensing section has detected the user to have gazed at the display device a predetermined number of times.

4. The information display system according to claim 3, wherein:
when the user is judged not to be gazing at the display device, the information displayed on the display device becomes stationary, and
when the user is judged to be gazing at the display device, the information displayed on the display device scrolls by moving at least one of upward, downward, left, and right.

5. An information display system comprising at least:
a display device which is wearable on a head of a user; and
a state sensing section which detects an active state of the user;
wherein the state sensing section detects whether or not the user is gazing at an electronic image displayed on the display device, and when the user is judged not to be gazing at the display device, the display on the display device is turned OFF, and when the user is judged to be gazing at the display device, the display device displays information stored in a memory.

6. The information display system according to claim 1, further comprising:
a notifying unit which notifies a start of information display to the user;
wherein when the user is judged not to be gazing at the display device, the user is notified of the start of the information display through the notifying unit.

7. The information display system according to claim 6, wherein the notifying unit notifies the start of the information display to the user by at least any one of a sound, vibration, light, and an electric pulse.

8. The information display system according to claim 1, wherein when the user is judged not to be gazing at the display device, the user is notified about the start of the information display by at least any one of a flashing display, a switching of a color of an image, and an alternating display of a positive image and a negative image on the display device.

9. A head-mounted information display system comprising:
a display device; and
a control unit which controls an information display of the display device to be turned off when a user is judged to have closed eyes.
